(19) United States
(12) Patent Application Publication
(10) Pub. No.: US 2024/0287261 A1
(43) Pub. Date: Aug. 29, 2024

(54) METHOD FOR PRODUCING POLYMERIC NANOFIBER AGGREGATE, POLYMERIC NANOFIBER AGGREGATE, UNIAXIALLY ORIENTED POLYMERIC NANOFIBER AGGREGATE SUBSTRATE, AND LASER DESORPTION/IONIZATION MASS SPECTROMETRY SUBSTRATE

(71) Applicant: KABUSHIKI KAISHA TOYOTA CHUO KENKYUSHO, Nagakute-shi (JP)

(72) Inventors: Norihiro MIZOSHITA, Nagakute-shi (JP); Yuri SASAKI, Nagakute-shi (JP); Yumi SAIKI, Nagakute-shi (JP)

(73) Assignee: KABUSHIKI KAISHA TOYOTA CHUO KENKYUSHO, Nagakute-shi (JP)

(21) Appl. No.: 18/403,878

(22) Filed: Jan. 4, 2024

(30) Foreign Application Priority Data
Feb. 24, 2023 (JP) 2023-027675

(51) Int. Cl. C08J 3/075

(52) U.S. Cl. CPC C08J 3/075; C08J 2383/08

(57) ABSTRACT

A method for producing a polymeric nanofiber aggregate comprises the steps of: dispersing a specific water-insoluble self-assembly compound in one solvent of a specific organic solvent and a mixed solvent of the organic solvent and water to obtain a gel-like composition; replacing the organic solvent in the gel-like composition with water to obtain a water-replaced gel-like composition; squeezing the water-replaced gel-like composition by compressing the water-replaced gel-like composition in a plurality of directions substantially orthogonal to a longitudinal direction while setting the water-replaced gel-like composition free in the longitudinal direction to obtain a self-assembly fiber bundle; and polymerizing the self-assembly compound in the self-assembly fiber bundle to obtain an aggregate formed of polymeric nanofibers oriented in the longitudinal direction.

### BACKGROUND OF THE INVENTION

### Field of the Invention

The present invention relates to a method for producing a polymeric nanofiber aggregate, a polymeric nanofiber aggregate, a uniaxially oriented polymeric nanofiber aggregate substrate, and a laser desorption/ionization mass spectrometry substrate.

### Related Background Art

Porous substrates having vertically oriented structures are expected to be applied to various fields from the viewpoints of improvements of optical and electronic devices and their functions (improvements of light absorption performance, expansions of surface areas, ensuring of conductive buses, ensuring of smooth substance diffusions, and the like). The usages of such porous substrates include, for example, a laser desorption/ionization mass spectrometry substrate. As a technique using such a laser desorption/ionization mass spectrometry substrate using a porous substrate having a vertically oriented structure, for example, a utilization of a silicon substrate having a nanopost (nanopillar) array structure formed by using a method of photolithography as a substrate for laser desorption/ionization mass spectrometry is disclosed in NPL 1 (Nicholas J. Morris et al., “Laser desorption ionization (LDI) silicon nanopost array chips fabricated using deep UV projection lithography and deep reactive ion etching”, Rsc Advances, vol. 5, 2015, P. 72051-P. 72057).

Note that although it is not a porous substrate having a vertically oriented structure, as a technique utilizing a substrate having a randomly oriented structure in laser desorption/ionization mass spectrometry substrate, for example, NPL 2 (Tian Lu et al., “Electrospun nanofibers as substrates for surface-assisted laser desorption/ionization and matrix-enhanced surface-assisted laser desorption/ionization mass spectrometry”, Analytical chemistry, vol. 85, issue 9, 2013, P. 4384-p. 4391) discloses utilization of an aggregate of resin nanofibers produced by electrospinning or a fiber-shaped carbon substrate obtained by calcining the aggregate as a substrate for laser desorption/ionization mass spectrometry.

### SUMMARY OF THE INVENTION

However, the technique as described in NPL 1 needs to employ at least 8 steps such as surface treatment, placement of a photoresist, formation of a pattern, and the like in production of a single substrate, which are complicated, and the technique is not satisfactory in terms of production efficiency (an increase in speed and a reduction in cost of formation of a substrate, and the like).

On the other hand, although the technique as described in NPL 2 is a technique that applies an aggregate of resin nanofibers to a substrate for laser desorption/ionization mass spectrometry, since electrospinning is used in the method for producing a substrate, only a fiber-shaped structural article that is randomly oriented can be obtained. Meanwhile, NPL 2 does not disclose at all formation of a uniaxially oriented fiber-shaped structural article and the like.

The present invention has been made in view of the above-described problems of the conventional techniques, and an object thereof is to provide a method for producing a polymeric nanofiber aggregate capable of efficiently producing a polymeric nanofiber aggregate uniaxially oriented in a longitudinal direction; a polymeric nanofiber aggregate obtained by using the production method; a uniaxially oriented polymeric nanofiber aggregate substrate capable of being efficiently produced as cut products of the polymeric nanofiber aggregate; and a laser desorption/ionization mass spectrometry substrate using the uniaxially oriented polymeric nanofiber aggregate substrate.

As a result of earnestly conducting studies in order to achieve the above-described objects, the present inventors have found that it is possible to efficiently produce a polymeric nanofiber aggregate uniaxially oriented in a longitudinal direction by: first dispersing a water-insoluble self-assembly compound which has a polymerizable functional group and is capable of forming a fiber-shaped molecular assembly through self-assembly into one solvent of an organic solvent miscible with water and a mixed solvent of the organic solvent and water to form a gel-like composition; subsequently replacing the organic solvent in the gel-like composition with water to form a water-replaced gel-like composition; squeezing the water-replaced gel-like composition by compressing the water-replaced gel-like composition in a plurality of directions substantially orthogonal to a longitudinal direction while setting the water-replaced gel-like composition free in the longitudinal direction to form a self-assembly fiber bundle; and thereafter polymerizing a self-assembly compound in the self-assembly fiber bundle, and have completed the present invention.

Specifically, the present invention provides the following aspects.

[1] A method for producing a polymeric nanofiber aggregate comprising the steps of:
dispersing a water-insoluble self-assembly compound which has a polymerizable functional group and is capable of forming a fiber-shaped molecular assembly through self-assembly into one solvent of an organic solvent miscible with water and a mixed solvent of the organic solvent and water to obtain a gel-like composition;
replacing the organic solvent in the gel-like composition with water to obtain a water-replaced gel-like composition;
squeezing the water-replaced gel-like composition by compressing the water-replaced gel-like composition in a plurality of directions substantially orthogonal to a longitudinal direction while setting the water-replaced gel-like composition free in the longitudinal direction to obtain a self-assembly fiber bundle; and
polymerizing the self-assembly compound in the self-assembly fiber bundle to obtain an aggregate formed of polymeric nanofibers oriented in the longitudinal direction.

[2] The method for producing a polymeric nanofiber aggregate according to [1], wherein the polymerizable functional group is at least one group selected from the group consisting of a trialkoxysilyl group, a vinyl group, an acryloyl group, a methacryloyl group, a dienyl group, and a diacetylene group.

[3] The method for producing a polymeric nanofiber aggregate according to [1] or [2], wherein
the water-insoluble self-assembly compound is an organic silane compound having two or more amide bonds and two or more aromatic groups in a molecular backbone thereof, in which
the two or more aromatic groups are each a group having one aromatic ring selected from the group consisting of a naphthalimide ring, a triphenylamine ring, a pyrene ring, a perylene ring, and an acridone ring, and
two or more trialkoxysilyl groups as the polymerizable functional groups bind to the two or more aromatic groups, respectively.

[4] A polymeric nanofiber aggregate wherein nanofibers formed of a polymer of a water-insoluble self-assembly compound which has a polymerizable functional group and is capable of forming a fiber-shaped molecular assembly through self-assembly are oriented and aggregated in a longitudinal direction.

[5] A uniaxially oriented polymeric nanofiber aggregate substrate comprising:
a thin film formed of cut products of a polymeric nanofiber aggregate in which nanofibers formed of a polymer of a water-insoluble self-assembly compound which has a polymerizable functional group and is capable of forming a fiber-shaped molecular assembly through self-assembly are oriented and aggregated in a longitudinal direction, wherein
a cutting direction of the cut products is a direction substantially perpendicular to the longitudinal direction of the polymeric nanofiber aggregate.

[6] A laser desorption/ionization mass spectrometry substrate comprising:
the uniaxially oriented polymeric nanofiber aggregate substrate according to [5] or a hydrophobized product thereof.

Note that although the reason why the above-described object can be achieved by the present invention is not necessarily clear, the present inventors surmise as follows. Specifically, first of all, a fiber-shaped molecular assembly formed of a molecule of a compound capable of self-assembly is normally randomly oriented. Since such a randomly oriented fiber-shaped molecular assembly is an assembly of a low-molecular-weight compound, which is mechanically very vulnerable, the molecular assembly is thought to be impossible to mechanically process.

Under such circumstances, the present inventors have found that by using a water-insoluble compound (a raw material molecule) that has a polymerizable functional group and is capable of forming a fiber-shaped molecular assembly as a compound capable of self-assembly, and by dispersing the compound into one solvent of an organic solvent miscible with water (for example, an alcohol) and a mixed solvent of the organic solvent and the water to obtain a gel-like composition (a gel-like composition containing a molecular assembly in which the molecule is self-assembled in a fiber shape) by self-assembly of the molecule of the compound in the solvent, and then replacing the organic solvent contained in the gel-like composition with water, it becomes possible to allow the fiber-shaped molecular assembly in the composition to be capable of being mechanical processed. Note that the present inventors surmise that in the water-replaced gel-like composition obtained in this way, a state is formed in which the water-insoluble fiber-shaped molecular assembly is forced to be dispersed in the water medium, and the hydrophobic interaction among the molecules is strongly expressed, which reinforces the mechanical properties of the fiber-shaped molecular assembly and enables mechanical processing. Then, in the present invention, a step of using the aforementioned water-replaced gel-like composition having reinforced mechanical properties as above, and squeezing the water-replaced gel-like composition by compressing the water-replaced gel-like composition in a plurality of directions substantially orthogonal to a longitudinal direction while setting the water-replaced gel-like composition free in the longitudinal direction is conducted. This step causes the fiber-shaped molecular assembly in the composition to be oriented in the longitudinal direction. Then, after a bundle-shaped assembly (a self-assembly fiber bundle) is formed by orienting the fiber-shaped molecular assembly in the longitudinal direction in this way, by polymerizing the fiber-shaped molecular assembly in the self-assembly fiber bundle thus obtained, it is possible to efficiently produce a polymeric nanofiber aggregate uniaxially oriented in the longitudinal direction. In this way, the present invention makes it possible to conduct mechanical processing, which has conventionally been impossible, by improving the mechanical properties of the fiber-shaped molecular assembly by dispersing the water-insoluble self-assembly compound in the solvent and forcedly changing the organic solvent contained in the solvent with water, to thus make it possible to produce a uniaxially oriented polymeric nanofiber aggregate. In this way, by using a specific compound and employing a simple step such as replacement of a medium, the present invention makes it possible to uniaxially orient and process a fiber-shaped molecular assembly formed by a molecular self-assembly into a bundle shape, and by polymerizing and fixing the fiber-shaped molecular assembly, to produce a uniaxially oriented polymeric nanofiber aggregate. Therefore, the present invention is a method capable of efficiently producing a polymeric nanofiber aggregate without employing complicated steps.

In addition, by using the polymeric nanofiber aggregate obtained by the method for producing a polymeric nanofiber aggregate of the present invention, it also becomes possible to, continuously and stably at a high speed, produce a substrate (a uniaxially oriented polymeric nanofiber aggregate substrate: which is a substrate having a porous structure (a pillar array structure) in terms of the structure) including a thin film in which a polymer of a fiber-shaped compound is uniaxially oriented in a vertical direction by conducting a simple step of cutting the polymeric nanofiber aggregate in a direction substantially perpendicular to the longitudinal direction (preferably, the direction of shorter sides) to form a thin film. Hence, the present invention makes it possible to efficiently produce a uniaxially oriented polymeric nanofiber aggregate substrate as well.

The present invention makes it possible to provide a method for producing a polymeric nanofiber aggregate capable of efficiently producing a polymeric nanofiber aggregate uniaxially oriented in a longitudinal direction; a polymeric nanofiber aggregate obtained by using the production method; a uniaxially oriented polymeric nanofiber aggregate substrate capable of being efficiently produced as cut products of the polymeric nanofiber aggregate; and a laser desorption/ionization mass spectrometry substrate using the uniaxially oriented polymeric nanofiber aggregate substrate.

### BRIEF DESCRIPTION OF THE DRAWINGS

FIG. 1 is a schematic diagram schematically showing a preferred embodiment of a cuboid-shaped water-replaced gel-like composition before compression and a self-assembly fiber bundle obtained by compressing the cuboid-shaped water-replaced gel-like composition.

FIG. 2 is a schematic diagram schematically showing preferred embodiments of a polymeric nanofiber aggregate and a thin film obtained by cutting the polymeric nanofiber aggregate.

FIG. 3 is an electron microscopic image (SEM image) showing a state (a randomly oriented state) of a nanofiber assembly in a gel-like composition obtained in Example 1.

FIG. 4 is an image showing a state (a state of aggregation of fibers) of a substantially rectangular column-shaped solid formed of the nanofiber assembly obtained in Example 1.

FIG. 5 is an electron microscopic image (SEM image) showing a state of the nanofiber assembly in the substantially rectangular column-shaped solid obtained in Example 1.

FIG. 6 is a graph of ²⁹Si MAS NMR spectrum of a polymeric nanofiber aggregate obtained in Example 1.

FIG. 7 is an image showing a state (a state of aggregation of polymeric nanofibers) of the polymeric nanofiber aggregate (organic silica nanofiber bundle) obtained in Example 1.

FIG. 8 is an electron microscopic image (SEM image) showing an oriented state of the polymeric nanofibers in an aggregate of the polymeric nanofibers obtained in Example 1.

FIG. 9 is an image showing an organic silica thin film obtained in Example 1.

FIG. 10 is an electron microscopic image (SEM image) showing a surface of the organic silica thin film obtained in Example 1.

FIG. 11 is an electron microscopic image (SEM image) showing a section of the organic silica thin film obtained in Example 1.

FIG. 12 is an image showing a plurality of organic silica thin films obtained in Example 1.

FIG. 13 is an electron microscopic image (SEM image) showing a surface of an organic silica thin film obtained in Example 2.

FIG. 14 is an electron microscopic image (SEM image) showing a section of the organic silica thin film obtained in Example 2.

FIG. 15 is an electron microscopic image (SEM image) showing a surface of an organic silica thin film obtained in Example 3.

FIG. 16 is an electron microscopic image (SEM image) showing a section of the organic silica thin film obtained in Example 3.

FIG. 17 is an electron microscopic image (SEM image) showing a surface of a thin film obtained in Comparative Example 1.

FIG. 18 is an electron microscopic image (SEM image) showing a section of the thin film obtained in Comparative Example 1.

FIG. 19 is images showing states of a gel-like composition before and after compression, which was produced in Comparative Example 2.

FIG. 20 is a graph showing load-displacement characteristics of the gel-like composition (the type of the solvent: a mixed solvent) and the water-replaced gel-like composition (the type of the solvent: water) at the time of compression as measured in Comparative Example 2.

FIG. 21 is a graph showing a mass spectrum of verapamil measured in Example 4.

FIG. 22 is a graph showing a mass spectrum of angiotensin I measured in Example 4.

FIG. 23 is a graph showing a mass spectrum of amyloid β measured in Example 4.

FIG. 24 is a graph showing a mass spectrum of verapamil measured in Comparative Example 3.

FIG. 25 is a graph showing a mass spectrum of angiotensin I measured in Comparative Example 3.

FIG. 26 is a graph showing a mass spectrum of amyloid β measured in Comparative Example 3.

FIG. 27 is a graph showing a signal intensity of the mass spectrum of each molecule to be analyzed (verapamil, angiotensin I, and amyloid β) measured in Example 4 and Comparative Example 3.

### DETAILED DESCRIPTION OF THE PREFERRED EMBODIMENTS

Hereinafter, the present invention will be described in detail based on preferred embodiments. Note that in the following description, the preferred embodiments and the like of the present invention will be described with reference to the drawings for convenience in some cases. In addition, the same or similar elements are denoted by the same signs and repetitive descriptions are omitted in the following descriptions and the drawings.

### [Method for Producing a Polymeric Nano Fiber Aggregate]

A method for producing a polymeric nanofiber aggregate of the present invention comprises the steps of:
dispersing a water-insoluble self-assembly compound which has a polymerizable functional group and is capable of forming a fiber-shaped molecular assembly through self-assembly into one solvent of an organic solvent miscible with water and a mixed solvent of the organic solvent and water to obtain a gel-like composition (hereinafter sometimes referred to simply as a “first step”);
replacing the organic solvent in the gel-like composition with water to obtain a water-replaced gel-like composition (hereinafter sometimes referred to simply as a “second step”);
squeezing the water-replaced gel-like composition by compressing the water-replaced gel-like composition in a plurality of directions substantially orthogonal to a longitudinal direction while setting the water-replaced gel-like composition free in the longitudinal direction to obtain a self-assembly fiber bundle (hereinafter sometimes referred to simply as a “third step”); and
polymerizing the self-assembly compound in the self-assembly fiber bundle to obtain an aggregate formed of polymeric nanofibers oriented in the longitudinal direction (hereinafter sometimes referred to simply as a “fourth step”). Hereinafter, each step will be separately described.

### <First Step>

The first step is a step of dispersing a water-insoluble self-assembly compound (hereinafter sometimes referred to simply as a “self-assembly compound” for convenience) which has a polymerizable functional group and is capable of forming a fiber-shaped molecular assembly through self-assembly into one solvent of an organic solvent miscible with water and a mixed solvent of the organic solvent and water to obtain a gel-like composition.

The self-assembly compound used in such a step needs to have a polymerizable functional group. Such a polymerizable functional group makes it possible to fix the oriented state through polymerization in the fourth step. In addition, the number of polymerizable functional groups contained in one molecule of the self-assembly compound is not particularly limited but is preferably 2 to 8, and more preferably 2 to 4. If the number of the polymerizable functional groups is equal to or more than the lower limit or more, it becomes possible to obtain higher advantageous effects in terms of structure stabilization by efficient formation of a cross-linkage structure than the case where the number of the polymerizable functional groups is less than the lower limit. On the other hand, if the number of the polymerizable functional groups is equal to or less than the upper limit, it becomes possible to obtain higher advantageous effects in terms of reducing deformation or volume shrinkage due to polymerization than the case where the number of the polymerizable functional groups exceeds the upper limit.

In addition, the polymerizable functional group is not particularly limited but is preferably a trialkoxysilyl group, a vinyl group, an acryloyl group, a methacryloyl group, a dienyl group, or a diacetylene group, more preferably a trialkoxysilyl group or a dienyl group, and particularly preferably a trialkoxysilyl group, from the viewpoint of ensuring high reactivity in a solid state. Such a trialkoxysilyl group includes, for example, a trimethoxysilyl group, a triethoxysilyl group, a tripropoxysilyl group, a triisopropoxysilyl group, and the like. Note that in the case where a plurality of polymerizable functional groups are contained in one molecule of the self-assembly compound, the plurality of polymerizable functional groups may be the same type as each other, or may be different types from each other. In this way, one type of a group may be used alone or two or more types of groups may be used in combination as the polymerizable functional group in the self-assembly compound.

In addition, the self-assembly compound is a compound which is capable of forming a fiber-shaped molecular assembly through self-assembly and is also water-insoluble. Here, the “fiber-shaped” only has to be a shape having a sufficiently long length relative to the diameter (preferably, the ratio of the length to the diameter is 10 times or more), and is a concept encompassing thin elongated shapes such as so-called a fiber-shape, line-shape, string-shape, needle-shape, and column-shape (Note that the fiber mentioned herein may be straight line-shaped or may have a branch).

As such a compound (molecule) which is capable of forming a fiber-shaped molecular assembly through self-assembly, a publicly-known compound (for example, a compound described in NPL 3 (Sukumaran Santhosh Babu et al., “Functional π-Gelators and Their Applications”, Chem. Rev., 2014, vol. 114, No. 4, P. 1973-P. 2129), a compound described in NPL 4 (Neralagatta M. Sangeetha et al., “Supramolecular gels: Functions and uses”, Chem. Soc. Rev., 2005, vol. 34, P. 821-P. 836), or the like) can be used as appropriate. Note that since the self-assembly compound has a polymerizable functional group, for example, a compound may be prepared by introducing a polymerizable functional group into the compounds (molecules) described in NPLs 3 to 4 and used as appropriate. In this way, as the self-assembly compound, for example, it is possible to use a compound which has a molecular backbone formed of a compound publicly-known as a compound which is capable of forming a fiber-shaped molecular assembly through self-assembly (the compound described in NPL 3 to 4 or the like), and in which a polymerizable functional group binds to the molecular backbone directly or via a linking group (for example, an alkylene group or the like). Note that a method for introducing a polymerizable functional group into a compound which is capable of forming a fiber-shaped molecular assembly through self-assembly is not particularly limited, and a publicly-known method which makes it possible to introduce a polymerizable functional group can be employed as appropriate.

The molecular backbone of the self-assembly compound includes, for example, amino acid-derived alkylamide compounds, oligoamino acid-derived alkylamide compounds, cyclic oligoamino acid derivatives, N,N′,N″-trialkyl-substituted benzenetricarboxamides, N,N′,N″-trialkyl-substituted cyclohexanetricarboxamides, N,N′-dialkyl-substituted cyclohexanedicarboxamides, N,N′,N″-trialkyl-substituted triureido cyclohexanes, N,N′-dialkyl-substituted diureido cyclohexanes, alkylenediamide derivatives, alkylenediureide derivatives, dialkoxyanthracene derivatives, dialkoxyanthraquinone derivatives, steroid derivatives, porphyrin derivatives, phthalocyanine derivatives, naphthalimide derivatives, naphthalene bisimide derivatives, perylene bisimide derivatives, alkoxy-substituted oligo-phenylenevinylene compounds, dibenzylidene sorbitol derivatives, gluconamide derivatives, triphenylamine derivatives, pyrene derivatives, perylene derivatives, acridone derivatives, diphenylpyrene derivatives, tetraphenylpyrene derivatives, methyl acridone derivatives, styrylbenzene derivatives, divinylbenzene derivatives, fluorene derivatives, quaterphenyl derivatives, anthracene derivatives, acridine derivatives, phenylpyridine derivatives, divinylpyridine derivatives, diketopyrrolopyrrole derivatives, dithienyl benzothiazole derivatives, or those obtained by binding two or more of these, and the like. Note that the molecular backbone of the self-assembly compound is not limited to the above-described examples, and a molecular backbone in an organic silyl compound which will be described later can also be used, for example.

The molecular backbone of the self-assembly compound is not particularly limited, and for example, N-benzyloxycarbonyl-L-isoleucineoctadecylamide, N-benzyloxycarbonyl-L-valineoctadecylamide, N-benzyloxycarbonyl-L-baryl-L-valineoctadecylamide, N-benzyloxycarbonyl-L-isoleucil-L-isoleucil-L-isoleu cinedodecylamide, cyclo(L-β-3,7-dimethyloctylasparaginyl-L-phenylalany 1), cyclo(L-β-2-ethylhexylasparaginyl-L-phenylalanyl), N,N′,N″-tristearyltrimesamide, cis,cis-1,3,5-tris(stearylaminocarbonyl)cyclohexan, trans-1,2-bis(undecylcarbonylamino)cyclohexan, trans-1,2-bis(N-octadecyl-ureido)cyclohexane, 1,12-bis(N-benzyloxycarbonyl-L-baryl)aminododecan, 1,12-bis(N-dodecyl-ureido)dodecan, 2,3-bis(decyloxy)anthracene, 2,3-bis(decyloxy)-9,10-anthraquinone, cholesteryl-4-(2-anthryloxy)butanoate, cholesteryl-anthraquinone-2-carboxylate, meso-tetrakis butt(p-carboxyphenyl)porphyrin-trihexadecyl ester, (2-cholesteryloxycarbonylaminoethyl)aminocarbonyltri s(tert-butyl)-Zn(II)-phthalocyanine, N—(N′-benzyloxycarbonyl-L-phenylalanylamino)-1,8-nap hthalimide, N,N′-bis[2-(3,4,5-trioctyloxyphenylcarbonylamino)eth yl]-1,4,5,8-naphthalene bisimide, N,N′-bis[2-(3,4,5-trioctyloxyphenylcarbonylamino)eth yl]-3,4,9,10-perylene bisimide, 1,4-bis(4-hydroxymethyl-2,5-dioctyloxystyryl)-2,5-di octyloxybenzene, dibenzylidene sorbitol, N-octyl-D-gluconamide-6-benzoate, and the like, and also a molecular backbone represented by the following formula (IA):

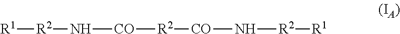

(wherein two R¹ each independently represent an aromatic group having one cyclic structure selected from the group consisting of a naphthalimide ring, a triphenylamine ring, a pyrene ring, a perylene ring, and an acridone ring, and a plurality of R² each independently represent an alkylene group having 2 to 16 carbon atoms) may be used.

Among such molecular backbones, a molecular backbone represented by the above-described formula (I_{A}) is more preferable from the viewpoint that such a molecular backbone contains an “organic group having a wavelength of maximum absorption within a wavelength range of 200 to 600 nm (for example, naphthalimide, triphenylamine, pyrene, perylene, acridone, and the like)” in the backbone and makes it possible to conduct analysis with higher sensitivity when used in a laser desorption/ionization mass spectrometry substrate.

In addition, such a self-assembly compound needs to be water-insoluble. Here, “water-insoluble” means that in a case where the compound is mixed with water (desirably, so-called pure water) under a temperature condition of 20° C. and thereafter recovered and dried, a difference between the mass of the compound before mixed with water and the mass of the compound after mixed with water is 0.1% by mass or less of the mass of the compound before mixed with water (such a property that the solubility to water can be considered as substantially 0 under a temperature condition of 20° C.). Hence, as the self-assembly compound, one that satisfies the above-described water-insoluble condition may be selected as appropriate from the aforementioned compounds.

In addition, as the self-assembly compound, organic silane compounds having a site that is capable of hydrogen bond, an aromatic group which is an organic group having a wavelength of maximum absorption within a wavelength range of 200 to 600 nm (a group having an aromatic ring having a wavelength of maximum absorption within a wavelength range of 200 to 600 nm), and a trialkoxysilyl group as a polymerizable functional group (hereinafter referred to as an “organic silane compound (A-1)” for convenience) are more preferable, and among these, an organic silane compound having two or more (more preferably 2 to 8) amide bonds and two or more (more preferably 2 to 4) aromatic groups in a molecular backbone, in which the two or more aromatic groups are each a group having one aromatic ring selected from the group consisting of a naphthalimide ring, a triphenylamine ring, a pyrene ring, a perylene ring, and an acridone ring, and two or more trialkoxysilyl groups as polymerizable functional groups bind (may be bind directly or may be bind via linking groups) to each of the two or more aromatic groups (hereinafter referred to as an “organic silane compound (A-2)” for convenience) is more preferable, and an organic silane compound having a molecular backbone represented by the above-described formula (I_{A}), in which two or more trialkoxysilyl groups as the polymerizable functional groups bind (may be bind directly or may be bind via linking groups) to each of aromatic groups represented by R¹ which is included in the molecular backbone (hereinafter referred to as an “organic silane compound (A-3)” for convenience) is particularly preferable. Note that in the case where such an organic silane compound (A-1) (more preferably, a compound (A-2), and further preferably, a compound (A-3)) is used as the self-assembly compound, polymeric nanofibers (fiber-shaped organic silica) obtained after polymerization of the compound can be made of an organic silica compound, and it becomes possible to obtain a polymeric nanofiber aggregate having the fiber-shaped organic silica as a structural unit.

The site that is capable of hydrogen bond (hydrogen bond site) which such an organic silane compound (A-1) has is not particularly limited, but includes, for example, an amide bond (a bond represented by —NH—CO—), a urethane bond (a bond represented by —NH—COO—), a urea bond (a bond represented by —NH—CO—NH—), a hydroxyl group (—OH), an imidazole group, an aminopyridyl group, and the like. Such a hydrogen bond site makes it possible to promote the formation of a fiber-shaped molecular assembly by a series of formation of hydrogen bonds, and further, in the case where a substrate formed by using the compound is used as a substrate for laser desorption/ionization mass spectrometry, it becomes possible to adsorb molecules to be measured, particularly highly hydrophilic compounds such as biologically relevant molecules to more uniformly support the molecules to be measured on the substrate. As such a hydrogen bond site, an amide bond (amide group) is particularly preferable because the amide bond (amide group) makes it possible to more improve the adsorption performance of the molecule to be measured. In addition, it is preferable that the hydrogen bond site (preferably, an amide bond) bind to the aromatic group directly or indirectly (via another element). This causes the hydrogen bond sites to be regularly arranged in the backbone of the substrate, and makes the adsorption sites of the molecule to be measured homogeneous in laser desorption/ionization mass spectrometry, thus improving the uniformity of the detection intensity of signals corresponding to the molecule to be measured. Note that as the organic silane compound (A-1) having an amide bond as the hydrogen bond site, specifically the above-described organic silane compounds (A-2) and (A-3) are preferable.

The aromatic group in the organic silane compound (A-1) is an organic group having a wavelength of maximum absorption within a wavelength range of 200 to 600 nm (a group having an aromatic ring having a wavelength of maximum absorption within a wavelength range of 200 to 600 nm). Such an aromatic ring having a wavelength of maximum absorption within a wavelength range of 200 to 600 nm is not particularly limited, and publicly-known aromatic ring (a naphthalimide ring, a triphenylamine ring, a pyrene ring, a diphenylpyrene ring, a tetraphenylpyrene ring, a perylene ring, a perylenebisimide ring, an acridone ring, a methylacridone ring, a styrylbenzene ring, a divinylbenzene ring, a fluorene ring, a quaterphenyl ring, an anthracene ring, an acridine ring, a phenylpyridine ring, a divinylpyridine ring, a porphine ring, a phthalocyanine ring, a diketopyrrolopyrrole ring, a dithienyl benzothiazole ring, and the like) can be used as appropriate. Among these, a naphthalimide ring, a triphenylamine ring, a pyrene ring, a perylene ring, and an acridone ring are more preferable from the viewpoint of chemical stability against irradiation with laser light. In addition, the organic silane compound (A-1) may contain one type of alone or may contain two or more aromatic groups. As the organic silane compound (A-1) containing a group having one type of aromatic ring selected from the group consisting of a naphthalimide ring, a triphenylamine ring, a pyrene ring, a perylene ring, and an acridone ring which are preferable as such an aromatic group, specifically the organic silane compounds (A-2) and (A-3) are preferable. Moreover, in the organic silane compounds (A-1) to (A-3), from the viewpoint of ensuring absorbance performance of near-ultraviolet light and high chemical stability against light irradiation, the aromatic group is particularly preferably a group having a naphthalimide ring. Note that the aromatic group only has to have any of the above-mentioned various rings, and may be the ring itself or may be one in which a substituent binds to the ring. Such a substituent is not particularly limited, but includes an alkyl group, an alkoxy group, a phenyl group, a phenoxy group, a nitro group, a cyano group, an amino group, a hydroxyl group, a thiol group, a thioalkyl group, a halogen group, and the like.

In addition, in the organic silane compounds (A-1) to (A-3), the trialkoxysilyl group preferably binds to the aromatic group directly or via a linking group. In addition, in the organic silane compounds (A-1) to (A-3), the upper limit for the number of trialkoxysilyl groups binding to the aromatic group is not particularly limited but is preferably 6 or less, more preferably 4 or less, and particularly preferably 3 or less. If the number of silyl groups binding to one aromatic group is more than the upper limit, the proportion of the laser light-absorptive organic groups decreases, so that the absorption efficiency for laser light tends to decrease. In addition, in the case where a trialkoxysilyl group binds to the molecular backbone directly or via a linking group, such a linking group is not particularly limited but is preferably an alkylene group, and among alkylene groups, from the viewpoint that preparation of the compound is easier, an ethylene group, a propylene group, or a butylene group are preferable, and an ethylene group is particularly preferable.

In addition, the organic silane compounds (A-2) and (A-3) are compounds having two or more amide bonds (two in the compound (A-3)). The upper limit for the number of such amide bonds is not particularly limited but is preferably 6 or less, more preferably 4 or less, and further preferably 3 or less. If the number of such amide bonds is more than the upper limit, it tends to be difficult for the molecule to be measured supported on the substrate to be desorbed in laser desorption/ionization mass spectrometry. Note that the number of the amide bonds is more preferably 2 from the viewpoint that it becomes possible to express adequate adsorption performance and to efficiently conduct laser desorption/ionization mass spectrometry.

In addition, as the organic silane compound (A-3), an organic silane compound represented by the following general formula (i):

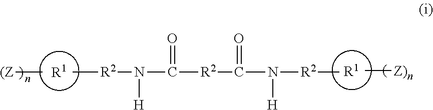

where two cyclic organic groups R¹ each independently represent an aromatic group having one cyclic structure selected from the group consisting of a naphthalimide ring, a triphenylamine ring, a pyrene ring, a perylene ring, and an acridone ring (particularly preferably, a group derived from a naphthalimide), a plurality of R² each independently represent an alkylene group having 1 to 5 (further preferably 2 to 3) carbon atoms (particularly preferably, an ethylene group), Z represents an organic group containing a trialkoxysilyl group (which may be a group binding to a cyclic organic group R¹, and may be a trialkoxysilyl group itself or an organic group containing a trialkoxysilyl group and a linking group (a group binding the cyclic organic group R¹ and the trialkoxysilyl group), and n represents the number of organic groups Z binding to the cyclic organic group R¹ and is an integer of 2 to 3 (more preferably 2) is particularly preferable (note that the trialkoxysilyl group in such a compound is preferably a trimethoxysilyl group, a triethoxysilyl group, or a tripropoxysilyl group, and the linking group linking the trialkoxysilyl group to the cyclic organic group R¹ is preferably an ethylene group, a propylene group, or a butylene group). Note that the method for producing such an organic silane compound is not particularly limited, and a publicly-known method can be employed as appropriate.

In addition, in the first step, the self-assembly compound is dispersed into one solvent of an organic solvent miscible with water and a mixed solvent of the organic solvent and water. Such an organic solvent miscible with water used as a solvent may be a water-soluble solvent known to be capable of being mixed with water and is not particularly limited, and for example, alcohols (ethanol, methanol, propanol, and the like), acetone, acetonitrile, tetrahydrofuran, dimethylformamide, dimethylacetamide, dimethyl sulfoxide, pyridine, triethylamine, and the like can be used. Note that in the case of using the above-described organic solvent as a solvent into which the self-assembly compound is dispersed, one of the organic solvents may be used alone or two or more of these may be used in a mixture.

In addition, in the case of using a mixed solvent of the above-described organic solvent (the organic solvent miscible with water) and water as a solvent into which the above-described self-assembly compound is disposed, the content of the organic solvent in the solvent is preferably 50% by mass or more (more preferably 60 to 95% by mass, and further preferably 65 to 90% by mass). If the content of such a organic solvent is equal to or more than the lower limit, it becomes possible to obtain higher advantageous effects in terms of the solubility of the self-assembly compound at the time of heating than the case where the content is less than the lower limit. On the other hand, if the content of such a organic solvent is equal to or less than the upper limit, it becomes possible to obtain higher advantageous effects in terms of efficient formation of fibers at around room temperature and a reduction in proportion of the dissolved self-assembly compound than the case where the content exceeds the upper limit. Note that as the organic solvent in such a mixed solvent, one of these may be used alone or two or more of these may be used in mixture.

Note that in the present invention, since the organic solvent itself or the mixed solvent containing the organic solvent is used as the solvent, at least an “organic solvent miscible with water” is used in using any solvent. By using such an “organic solvent miscible with water”, in the present invention, it becomes possible to more efficiently generate a fiber-shaped molecular assembly in the case of employing a heating and cooling step described later in the first step, and allow a gel-like composition obtained in the first step to contain an organic solvent without exception. Hence, in the following second step, in the case where the gel-like composition containing the organic solvent is subjected to a simple step such as immersion into a large amount of water, for example, it becomes possible to mix the organic solvent with water (into a uniformly mixed liquid of the organic solvent and water), and to easily cause replacement of the organic solvent and water contained in the gel-like composition to proceed such that the concentration of the organic solvent in water becomes uniform, thus making it possible to efficiently produce a desired water-replaced gel-like composition.

In addition, in the first step, the self-assembly compound is dispersed in the organic solvent or the mixed solvent. However, from the viewpoint that more efficient production of a fiber-shaped molecular assembly is made possible by employing a heating and cooling step described later, it is preferable to disperse the self-assembly compound into the mixed solvent.

In addition, when the self-assembly compound is dispersed into the solvent (the organic solvent or the mixed solvent), the amount of the self-assembly compound to be added into the solvent is preferably 0.5 to 10% by mass, and preferably 1 to 3% by mass, relative to the total amount of the solvent and the self-assembly compound. If the amount (ratio) of the self-assembly compound to be added into the solvent is less than 0.5% by mass, there is a tendency that a mixture of the organic solvent and the fiber-shaped molecular assembly formed by the self-assembly compound cannot maintain a macroscopic shape as a gel, making it difficult to obtain a gel-like composition. On the other hand, if the amount (ratio) of the self-assembly compound to be added into the solvent exceeds 10% by mass, the ratio of the organic solvent is small to lower the compression rate in compression after the organic solvent is replaced with water, thus leading to a tendency that the orientation decreases in orienting the fiber-shaped molecular assembly.

In addition, when the self-assembly compound is dispersed into the solvent (the organic solvent or the mixed solvent), it becomes possible to more efficiently form more homogeneous nanofibers by cooling after uniform dissolution by heating. Hence, it is preferable to employ a step (a heating and cooling step) of cooling to room temperature (25° C.) after dissolving the self-assembly compound in the solvent by heating to 70 to 100° C. (more preferably 75 to 85° C.) after the self-assembly compound is added into the solvent.

By dispersing the self-assembly compound into the solvent (the organic solvent or the mixed solvent) in this way, it becomes possible to obtain a gel-like composition. Note that such a gel-like composition is one formed by a mixture of the fiber-shaped molecular assembly formed by the self-assembly compound (nanofibers generated by molecular self-assembly) and the solvent. Note that since the organic solvent is contained in the solvent included in the gel-like composition without exception, the gel-like composition contains at least the organic solvent together with the fiber-shaped molecular assembly. Note that since the fiber-shaped molecular assembly is basically randomly oriented in a composition to make a net-shaped nano structure (nanofibers), it is considered that the solvent is taken into the net-shaped cavity portions in the composition thus obtained, so that the composition becomes gel-like.

### <Second Step>

The second step is a step of replacing the organic solvent in the gel-like composition with water to obtain a water-replaced gel-like composition.

The method for replacing the organic solvent in the gel-like composition with water is not particularly limited, and a publicly-known method can be employed as appropriate. For example, a method for replacing the organic solvent with water by immersing the gel-like composition into water can be favorably employed. In the case of employing a method that immerses the gel-like composition into water as the method for replacing the organic solvent in the gel-like composition with water, it is preferable that the gel-like composition be immersed into water and left standing for 1 to 3 days from the viewpoint of causing the replacement to sufficiently proceed. By replacing the organic solvent with water in this way, it is possible to obtain a water-replaced gel-like composition.

Note that the present inventors surmise that in the water-replaced gel-like composition obtained in this way, since it becomes possible to cause hydrophobic interaction between molecules of the self-assembly compound which is water-insoluble to more intensely express, the mechanical properties of the fiber-shaped molecular assembly in the composition are reinforced, making it possible to conduct mechanical processing as employed in the third step described later.

### <Third Step>

The third step is a step of squeezing the water-replaced gel-like composition by compressing the water-replaced gel-like composition in a plurality of directions substantially orthogonal to a longitudinal direction while setting the water-replaced gel-like composition free in the longitudinal direction to obtain a self-assembly fiber bundle.

Here, as the “longitudinal direction” in compressing the water-replaced gel-like composition, for example, in the case where the shape of the gel-like composition itself is a shape having different lengths of the longitudinal side, the lateral side, and the height (for example, in the case where of a substantially cuboid or the like), the direction of the longer side among these may be employed. On the other hand, in the case where the gel-like composition has a substantially cubic shape and the lengths of the longitudinal side, the lateral side, and the height are substantially equal to one another, a direction perpendicular to one surface of the gel-like composition may be employed as the longitudinal direction.

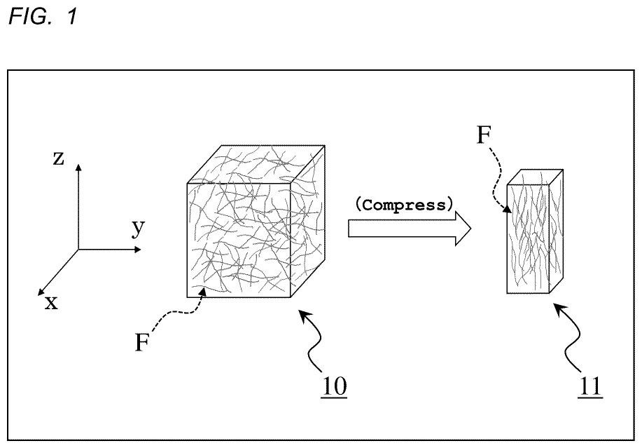

In addition, in the third step, the water-replaced gel-like composition is compressed in a plurality of directions substantially orthogonal to the longitudinal direction while the longitudinal direction thereof is opened. Such a compression step will be described with reference to FIG. 1. FIG. 1 is a schematic diagram schematically showing a preferred embodiment of a substantially cuboid-shaped water-replaced gel-like composition 10 before compression in which the z axial direction is the longitudinal direction and a self-assembly fiber bundle 11 obtained after the compression. Note that F in the composition 10 and the self-assembly fiber bundle 11 shown in FIG. 1 schematically expresses a fiber-shaped molecular assembly of the self-assembly compound (hereinafter sometimes referred to simply as “fibers F”).

In the water-replaced gel-like composition 10, as in the embodiment shown in FIG. 1, the fibers F do not have orientation, and the fibers F are directed in random directions to form a net shape. Such a water-replaced gel-like composition 10 is a structure (a gel containing water as a solvent) like a random dispersion of nanofibers (fibers F) of the self-assembly compound. Note that such a water-replaced gel-like composition 10 is in a state that can be subjected to mechanical processing without collapsing of the gel structure because the solvent is water. Then, in the embodiment shown in FIG. 1, the water-replaced gel-like composition 10 is squeezed by compressing the water-replaced gel-like composition 10 in two directions (the x direction and the y direction) orthogonal to the longitudinal direction (the z axial direction) to orient the fibers F in the composition in the longitudinal direction.

In this way, in the embodiment shown in FIG. 1, the water-replaced gel-like composition 10 is squeezed by compressing the water-replaced gel-like composition 10 in a plurality of directions (two directions of the x direction and the y direction substantially orthogonal to the longitudinal direction while setting the water-replaced gel-like composition 10 free in the longitudinal direction (the z axial direction). Here, as the directions substantially orthogonal to the longitudinal direction, for example, directions that are the same as or substantially the same as the radius directions of a circle in the case where the circle is drawn on the xy plane about the z axis may be employed. In this case, it becomes possible to compress the water-replaced gel-like composition 10 in a plurality of directions substantially orthogonal to the longitudinal direction by compressing the water-replaced gel-like composition 10 in two or more directions selected from directions that are the same as the radius direction and directions that are substantially the same as the radius directions (note that in the embodiment shown FIG. 1, both of the x direction and the y direction are radius directions of a circle in the case where the circle is drawn on the xy plane about the z axis). Note that the “directions substantially orthogonal to the longitudinal direction” mentioned herein may be directions that are substantially perpendicularly intersect the longitudinal direction (preferably directions that intersect the longitudinal direction at angles within a range of 90°±20°, and more preferably directions that intersect the longitudinal direction at angles within a range of 90°±15°). In addition, in the embodiment shown in FIG. 1, since the water-replaced gel-like composition 10 is compressed in two directions of the x direction and the y direction orthogonal to the longitudinal direction while the water-replaced gel-like composition 10 is set free in the longitudinal direction (without pressurizing in the longitudinal direction), force is applied to the fibers F in the composition 10 during the compression such that the fibers F are oriented in the longitudinal direction, thus making it possible to sufficiently uniformly orient the fibers F. In this way, in the present invention, since the composition 10 is squeezed by compressing the composition 10 in a plurality of directions substantially orthogonal to the longitudinal direction while setting the composition 10 free in the longitudinal direction, a state in which the fibers F are sufficiently uniformly oriented in the longitudinal direction can be obtained, and it thus becomes possible to obtain a self-assembly fiber bundle 11 in such a form that the fibers F are bundled.

As in the preferred embodiment shown in FIG. 1 as described above, by compressing the water-replaced gel-like composition in a plurality of directions substantially orthogonal to the longitudinal direction while setting the water-replaced gel-like composition free in the longitudinal direction, it becomes possible to squeeze the composition while sufficiently uniformly orienting the fiber-shaped molecular assembly in the composition. This makes it possible to obtain a self-assembly fiber bundle in such a form that the fiber-shaped molecular assembly in the self-assembly compound is bundled and aggregated in the state of being oriented in the longitudinal direction. Note that the conditions such as the compression rate in such compression are not particularly limited and may be set as appropriate depending on the type of the self-assembly compound, the content ratio (concentration) of the self-assembly compound in the water-replaced gel-like composition, the design of the object, and the like. For example, in the case where the self-assembly compound is the organic silane compound (A-1) to (A-3) and where the gel-like composition before water replacement is a gel-like composition in which the content ratio of the self-assembly compound is around 2% by mass (where the concentration of the fibers F is around 2% by mass), when the form of a water-replaced gel-like composition obtained by subjecting the gel-like composition to water replacement is substantially a cuboid, it is preferable to compress the water-replaced gel-like composition in two direction that are directions substantially orthogonal to the longitudinal direction and are also orthogonal to each other (the x direction and the y direction in the embodiment shown in FIG. 1) until the lengths in these directions are compressed to lengths of ⅕ to 1/7 (particularly desirably 1/7) times of these.

In addition, it is preferable to subject the self-assembly fiber bundle obtained in such a compression step to a drying step before subjecting the self-assembly fiber bundle to the fourth step described later to remove the solvent (water) inside the self-assembly fiber bundle. Such a drying step is not particularly limited, but for example, a step of heating the self-assembly fiber bundle at a temperature condition of 90 to 120° C. (more preferably 95 to 120° C.) for 1 to 12 hours (more preferable 3 to 6 hours) to remove water in the self-assembly fiber bundle can be employed.

### <Fourth Step>

The fourth step is a step of polymerizing the self-assembly compound in the self-assembly fiber bundle to obtain an aggregate formed of polymeric nanofibers oriented in the longitudinal direction.

The polymerization method for polymerizing the self-assembly compound as described above is not particularly limited, and a publicly-known polymerization method such as hydrolytic polycondensation, photopolymerization, thermal polymerization, or polyaddition can be employed as appropriate depending on the type of the polymerizable functional group in the compound and the like.

In addition, as such a polymerization method, in the case where the drying step is conducted on the self-assembly fiber bundle as mentioned above, it is preferable to employ a method including: exposing the self-assembly fiber bundle after being dried to acidic vapor (vapor containing an acidic catalyst) or basic vapor (vapor containing a basic catalyst) under heating conditions to polymerize the self-assembly compound (hereinafter, this method is sometimes referred to simply as a “polymerization method (i)” for convenience). Such acidic vapor includes, for example, vapor of hydrochloric acid, vapor of nitric acid, vapor of sulfuric acid, and the like. In addition, the basic catalyst includes, for example, vapor of ammonia water, vapors of aqueous solutions of alkyl amines, and the like. In addition, the heating conditions in the case of employing the above-described polymerization method (i) may be set as appropriate depending on the type of the polymerizable functional group in the self-assembly compound and the like and are not particularly limited, but it is preferable to conduct heating at a heating temperature of around 80 to 120° C. for around 1 to 48 hours. Exposure to vapor under such heating conditions makes it possible to promote reaction in the surface and inside of the self-assembly fiber bundle, and thus to cause polymerization to efficiently proceed. In addition, in the case of employing the above-described polymerization method (i), when the type of the polymerizable functional group in the self-assembly compound is a trialkoxysilyl group, since no residue remains by drying an aggregate obtained after polymerization, it is preferable to use vapor of hydrochloric acid or vapor of ammonia water as the vapor for exposure.

Polymerizing the self-assembly compound in the self-assembly fiber bundle makes it possible to polymerize and fix a fiber-shaped assembly (nanofibers) which is an oriented product in the self-assembly fiber bundle while maintaining the oriented state, and thus makes it possible to obtain an aggregate formed of polymeric nanofibers oriented in the longitudinal direction. That is, such a method makes it possible to obtain a polymeric nanofiber aggregate in which nanofibers (polymeric nanofibers) formed of a polymer of a water-insoluble self-assembly compound are oriented and aggregated in the longitudinal direction.

Polymeric nanofibers included in such an aggregate are preferably those having an average diameter within a range of 10 to 1000 nm (more preferably 20 to 800 nm). If the diameter of the nanofibers is less than the lower limit value, the structure of the nanofibers is destabilized and makes it difficult to handle a single nanofiber as a fiber-shaped structure. On the other hand, if the diameter of the nanofibers is more than the upper limit, the aggregate becomes larger than nano size, and even when the aggregate is made to have a porous structure, it becomes difficult to obtain optical electronic or physical effects. Note that such an average diameter can be measured by obtaining and averaging diameters of randomly selected 50 or more polymeric nanofibers through observation using a scanning electron microscope (SEM observation).

In addition, such polymeric nanofibers included in the aggregate are preferably those having an average length within a range of 1 to 500 μm (more preferably 10 to 100 μm). If the length of the nanofibers is less than the lower limit value, the fiber bundle tends to have a lowered orientation for the compression process. On the other hand, if the length of the nanofibers exceeds the upper limit value, bending or cutting of fibers occurs in the course of the compression process, and the fiber bundle tends to contain a finely divided molecular assembly. Note that such an average length can be measured by obtaining and averaging lengths of randomly selected 50 or more polymeric nanofibers through SEM observation.

In addition, such polymeric nanofibers included in the aggregate are preferably those whose ratio of the average length to the average diameter ([average length]/[average diameter]) is 10 to 1000 (more preferably 20 to 500). If such a ratio is less than the lower limit value, the fiber bundle tends to have a lowered orientation for compression process. On the other hand, if the ratio exceeds the upper limit value, bending or cutting of fibers occurs in the course of the compression process, and the fiber bundle tends to contain a finely divided molecular assembly.

In addition, after the aggregate formed of the polymeric nanofibers is obtained, the periphery of the aggregate may be covered and reinforced with a resin (cemented with a resin) in order to maintain the structure (oriented state and the like) of the aggregate. The resin that can be used for reinforcing the aggregate is not particularly limited, and for example, epoxy resin, acrylic resin, silicone resin, and the like can be used. By reinforcing the periphery of the aggregate with a resin, the processability of the aggregate is improved, and it becomes possible to more sufficiently maintain the oriented state of the nanofibers and more easily produce a porous thin film in the case of producing a thin film by cutting the aggregate, or the like, for example.

### [Polymeric Nanofiber Aggregate]

A polymeric nanofiber aggregate of the present invention is a polymeric nanofiber aggregate in which nanofibers formed of a polymer of a water-insoluble self-assembly compound which has a polymerizable functional group and is capable of forming a fiber-shaped molecular assembly through self-assembly are oriented and aggregated in a longitudinal direction. Such a “water-insoluble self-assembly compound which has a polymerizable functional group and is capable of forming a fiber-shaped molecular assembly through self-assembly” is the same as that described in terms of the method for producing a polymeric nanofiber aggregate of the present invention. In addition, “nanofibers” formed of a polymer of such a self-assembly compound are the same as the “polymeric nanofibers” described in terms of the method for producing a polymeric nanofiber aggregate of the present invention (preferred conditions thereof (for example, the average diameter and the like) are also the same). Hence, the “nanofibers” in the polymeric nanofiber aggregate of the present invention are formed of a polymer of an assembly of a self-assembly compound assembled into fiber shape through self-assembly. Such a polymeric nanofiber aggregate can be efficiently produced by the method for producing a polymeric nanofiber aggregate of the present invention.

### [Uniaxially Oriented Polymer Nanofiber Aggregate Substrate]

A uniaxially oriented polymeric nanofiber aggregate substrate of the present invention is a uniaxially oriented polymeric nanofiber aggregate substrate which comprises: a thin film formed of cut products of a polymeric nanofiber aggregate in which nanofibers formed of a polymer of a water-insoluble self-assembly compound which has a polymerizable functional group and is capable of forming a fiber-shaped molecular assembly through self-assembly are oriented and aggregated in a longitudinal direction, wherein a cutting direction of the cut products is a direction substantially perpendicular to the longitudinal direction of the polymeric nanofiber aggregate. Such a “self-assembly compound”, “nanofibers”, and “polymeric nanofiber aggregate” are the same as those described in terms of the polymeric nanofiber aggregate of the present invention.

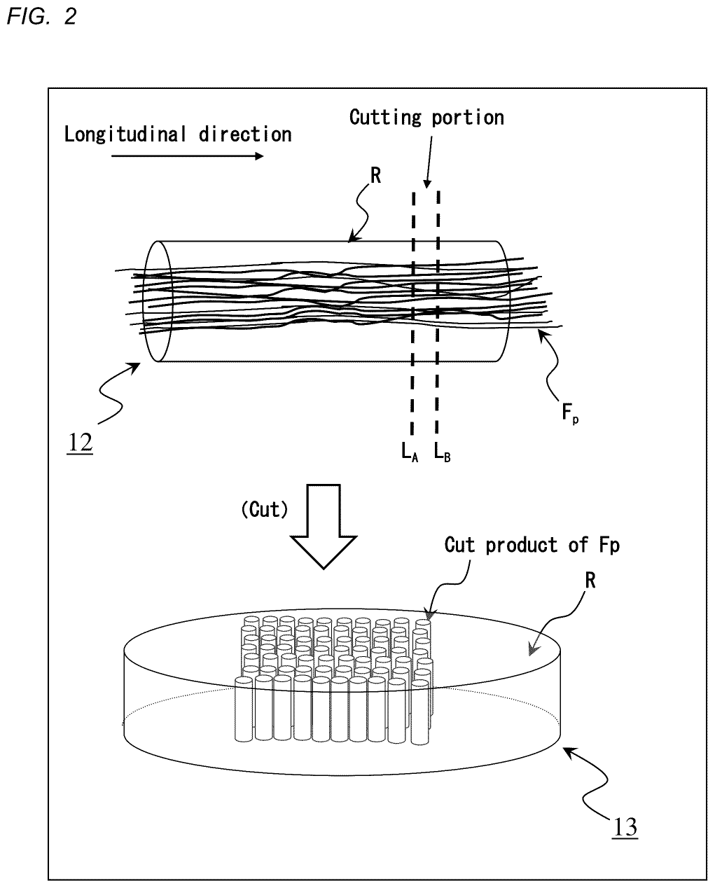

Such a uniaxially oriented polymeric nanofiber aggregate substrate of the present invention, in other words, can be said to comprise a thin film formed of cut products obtained by cutting the polymeric nanofiber aggregate in a direction substantially perpendicular to the longitudinal direction of the aggregate. Here, a preferred embodiment of a thin film formed of cut products will be briefly described with reference to FIG. 2.

FIG. 2 is a schematic diagram schematically showing a preferred embodiment of a polymeric nanofiber aggregate 12 in a form in which the periphery of an aggregate in which nanofibers Fₚ formed of a polymer are oriented and aggregated in a longitudinal direction is fixed (reinforced) with a resin R and a thin film 13 formed of cut products obtained by cutting the aggregate 12 at portions indicated by a dotted line L_{A} and a dotted line L_{B} (note that the direction of the dotted line L_{A} and the dotted line L_{B} is a direction perpendicular to the longitudinal direction of the aggregate 12).

As shown in FIG. 2, by forming a thin film by cutting the polymeric nanofiber aggregate 12 in a direction substantially perpendicular to the longitudinal direction thereof, it is possible to easily form a thin film in a state in which cut products (columnar articles of nano size) of fine polymeric nanofibers Fₚ are oriented substantially perpendicularly to a cut surface, owing to the oriented state of the polymeric nanofiber aggregate as the cut products are viewed from above the cut surface (a surface of the thin film). In this way, since the cut products (columnar articles of nano size) of the plurality of polymeric nanofibers Fₚ are oriented substantially perpendicularly to the surface of the thin film, this thin film can be used as one in which a porous surface formed of substantially perpendicularly oriented nanofibers (a surface having a pillar array structure) is formed. Then, in the case where a plurality of the thin films 13 are formed by cutting the polymeric nanofiber aggregate 12 at a plurality of portions, it becomes possible to produce the thin films 13 continuously at high speed and also at low cost. Hence, the present invention makes it possible to efficiently produce a uniaxially oriented polymeric nanofiber aggregate substrate in which polymeric nanofibers (cut products) are oriented in a direction substantially perpendicular to a surface of a thin film. Note that “substantially perpendicular to the longitudinal direction” means almost perpendicular to the longitudinal direction (preferably 90°±20°, and more preferably 90°±15°).

Note that although in the embodiment shown in FIG. 2, the thin film is formed by cutting the polymeric nanofiber aggregate 12 in the form in which the periphery is fixed (reinforced) with the resin R, such a resin R is the same as that described in terms of the aforementioned “resin that can be used for reinforcing the aggregate”. Note that although in the embodiment shown in FIG. 2, the polymeric nanofiber aggregate 12 in the form in which the periphery is fixed (reinforced) with the resin R is used, in the case where the shape of the polymeric nanofiber aggregate aggregated at the time of cutting can be maintained after the cutting, a polymeric nanofiber aggregate in a form in which the periphery is not reinforced with the resin R may be used and cut as it is. In this way, a thin film formed of cut products of the polymeric nanofiber aggregate (in the form that does not contain the resin R) may be produced. As described above, the form of the thin film is not particularly limited, and may be a form in which the periphery is fixed (reinforced) with the resin R or may be a form formed of cut products of a polymeric nanofiber aggregate in a form that is not reinforced with the resin R.

In addition, in the thin film which is formed of the cut products of the polymeric nanofiber aggregate and has the form in which the polymeric nanofibers (cut products) are oriented in a direction substantially perpendicular to the surface, an average distance between the polymeric nanofibers oriented in the substantially perpendicular direction (an average interval between the polymeric nanofibers) is preferably 1.0 time to 2.0 times (more preferably 1.1 times to 1.8 times) an average diameter of the polymeric nanofibers. If the average distance is shorter than the lower limit, there is a tendency that fusion of the polymeric nanofibers to the side proceeds and makes it difficult to form a porous structure (a pillar array structure or a nano concave-convex structure). On the other hand, if the average distance is longer than the upper limit, since physical cross-linkage due to contact of the polymeric nanofibers is not formed, there is a tendency that the orientation structure of the fibers in the structural article (thin film) after cutting (slicing) becomes unstable. Note that such an average interval between the polymeric nanofibers can be measured by measuring distances between the closest polymeric nanofibers in randomly selected 50 or more polymeric nanofibers and averaging the distances, by conducting SEM observation on the surface of the thin film.

In addition, the thickness of the thin film formed of the cut products of the polymeric nanofiber aggregate is preferably 0.2 to 300 μm (more preferably 0.3 to 50 μm). If the thickness of the thin film is less than the lower limit, there is a tendency that it becomes difficult to obtain a homogeneous section at the time of cutting. On the other hand, if the thickness of the thin film is more than the upper limit, there is a tendency that entrance of light or diffusion of the substance into the thin film becomes difficult, leading to a tendency that applicability as an optically functional material or the like decreases.

Moreover, the uniaxially oriented polymeric nanofiber aggregate substrate of the present invention only has to comprise the above-described thin film, and the form is not particularly limited, and for example, may be a thin film formed of the cut products of the polymeric nanofiber aggregate itself (may be one formed of independent one of the thin film), or may be a form obtained by fixing the thin film on a solid substrate (support). As such a uniaxially oriented polymeric nanofiber aggregate substrate of the present invention, a form obtained by fixing the cut surface on a support is preferable from the viewpoint of structural stability.

Such a support is not particularly limited, and publicly-known supports of a silicon base material (Si base material), an ITO base material, a FTO base material, a silica base material, a glass base material, various metal base materials, and various thin film base materials can be used as appropriate depending on the usage of the uniaxially oriented polymeric nanofiber aggregate substrate. Note that in the case where the usage of the uniaxially oriented polymeric nanofiber aggregate substrate is a substrate for laser desorption/ionization mass spectrometry, it is preferable to use a conductive substrate such as a silicon substrate, a stainless steel, an ITO base material, a ZnO base material, a SnO base material, or a FTO base material as such a support. In addition, the shape of such a support is not particularly limited but is preferably a flat plate shape. Note that the method for stacking the thin film on a support is not particularly limited, and a publicly-known method can be employed as appropriate, and for example, the thin film may be stacked on a support by attaching a piece of the thin film to one surface of a carbon seal (double-sided), and attaching the other surface (double-sided) to the support to attach the thin film onto the support. In addition, the uniaxially oriented polymeric nanofiber aggregate substrate in a form in which a piece of the thin film is protected by attaching one of the cut surfaces of the thin film to a carbon seal may be used as the uniaxially oriented polymeric nanofiber aggregate substrate as it is. As described above, the uniaxially oriented polymeric nanofiber aggregate substrate of the present invention only has to comprise the above-described thin film, and the form thereof is not particularly limited.

The method for producing such a uniaxially oriented polymeric nanofiber aggregate substrate is not particularly limited, and for example, the uniaxially oriented polymeric nanofiber aggregate substrate can be easily produced by conducting the step of: preparing the polymeric nanofiber aggregate by using the method for producing a polymeric nanofiber aggregate of the present invention, and cutting the aggregate in a direction substantially perpendicular to the longitudinal direction (see FIG. 2). Here, the method for cutting the polymeric nanofiber aggregate is not particularly limited, and a publicly-known method can be employed as appropriate. For example, a method for cutting the polymeric nanofiber aggregate into a desired thickness by using a publicly-known cutting device (for example, a rotary microtome or the like) that is capable of cutting a bulk material into a thin film shape may be employed. In addition, after a thin film is formed by cutting as described above, a step of fixing the thin film onto a support may be conducted as necessary. Note that such a fixing method is not particularly limited, and for example, a method for attaching the thin film to a surface of an adhesive substrate may be employed.

As described above, the uniaxially oriented polymeric nanofiber aggregate substrate of the present invention can be easily produced by cutting the above-described polymeric nanofiber aggregate. As described above, since a substrate including a thin film in which nanofibers are uniformly oriented can be produced by a convenient method such as cutting the above-described polymeric nanofiber aggregate, the uniaxially oriented polymeric nanofiber aggregate substrate of the present invention can be continuously and stably produced at low cost and at high speed. Hence, it is also possible to very efficiently produce substrates that can be applied to various usages depending on the surface structure of the substrate, the type of the polymer of the fibers, and the like. Further describing such a point, in order to produce a uniaxially oriented substrate having a vertically oriented nano concave-convex structure, it has generally been necessary to conduct particle growth, formation of a thin film, or surface treatment under unique conditions for each substrate (for example, PTL 1). In addition, since a fiber-shaped molecular assembly is mechanically fragile and cannot be subjected to a molding process, it has been impossible to orient nanofibers in one direction by convenient processing methods such as compression. In contrast, the present invention makes it possible to conduct such processing that the fiber-shaped molecular assembly formed through molecular self-assembly is oriented in one direction, and it is possible to easily produce the polymeric nanofiber aggregate by polycondensating (fixing) this molecular self-assembly into a bundle. Then, since a uniaxially oriented substrate (a uniaxially oriented polymeric nanofiber aggregate substrate) can be conveniently produced by a method such as simply cutting such a polymeric nanofiber aggregate, the present invention makes it possible to efficiently and continuously produce uniaxially oriented substrates. In addition, by introducing an organic group (functional site) that enables a self-assembly compound which serves as a raw material of a fiber-shaped molecular assembly to express a desired functionality, it is also possible to express a desired function (light absorption function or the like) in the formed fiber backbone structure itself. As described above, the present invention makes it possible to continuously produce a uniaxially oriented polymeric nanofiber aggregate substrate having desired properties at low cost, and for example, also makes it possible to continuously and stably produce a substrate that can be favorably used in a laser desorption/ionization mass spectrometry substrate by introducing an organic group or the like having a function of absorbing laser light or the like into a self-assembly compound to form nanofibers. Hence, the uniaxially oriented polymeric nanofiber aggregate substrate and the method for producing the substrate of the present invention can be particularly favorably applied to, for example, a laser desorption/ionization mass spectrometry substrate which is supposed to be used as a disposable substrate and a method for producing the same, and the like.

### [Laser Desorption/ionization Mass Spectrometry Substrate]

A laser desorption/ionization mass spectrometry substrate of the present invention is a laser desorption/ionization mass spectrometry substrate which comprises the uniaxially oriented polymeric nanofiber aggregate substrate of the present invention or a hydrophobized product thereof.

Note that the laser desorption/ionization mass spectrometry substrate of the present invention can be used for a publicly-known laser desorption/ionization mass spectrometry method (for example, a so-called matrix-assisted laser desorption/ionization mass spectrometry method (MALDI method), a laser desorption/ionization mass spectrometry method that does not use a matrix, and the like), and can employ a favorable analyzing method depending on the type of the polymeric nanofibers included in the substrate, and the like. Note that by using such a laser desorption/ionization mass spectrometry substrate of the present invention, for example, mass spectrometry can be conducted by supporting a molecule to be measured on the surface of the substrate to form a measurement sample in which the molecule to be measured is supported (for example, which may be supported by adding dropwise a sample solution containing the molecule to be measured (which may be a solution of a matrix (normally, a low molecular weight organic substance that absorbs laser light is used) and the molecule to be measured depending on the type of the analyzing method), or the like) on the surface of the substrate (which may be supported in the form of a mixture of the molecule to be measured and the matrix), and then irradiating the measurement sample with laser light.

Here, the laser desorption/ionization mass spectrometry substrate of the present invention uses the same one as the aforementioned uniaxially oriented polymeric nanofiber aggregate substrate of the present invention or a hydrophobized product thereof. Note that the uniaxially oriented polymeric nanofiber aggregate substrate of the present invention comprises a thin film in which a porous structure (pillar array structure (nano concave-convex structure)) having polymeric nanofibers (cut products) oriented in a direction substantially perpendicular to a surface of the substrate is formed on the surface as mentioned above. For this reason, when this uniaxially oriented polymeric nanofiber aggregate substrate or a hydrophobized product thereof is used in laser desorption/ionization mass spectrometry, it is possible to easily support a molecule to be measured on the substrate, owing to the porous structure of the surface of the thin film, by adding dropwise a solution of the molecule to be measured onto a surface (a portion having the porous structure) of a thin film portion of the substrate.

The uniaxially oriented polymeric nanofiber aggregate substrate (or a hydrophobized product thereof) of the present invention used in the laser desorption/ionization mass spectrometry substrate of the present invention is preferably one in which “nanofibers formed of a polymer of a self-assembly compound” oriented and aggregated in the longitudinal direction in the thin film of the substrate are formed by using the above-described organic silane compound (A-1) (more preferably the organic silane compound (A-2), and further preferably the organic silane compound (A-3)) as the self-assembly compound, that is, one formed of a fiber-shaped organic silica formed of a polymer of the above-described organic silane compound (A-1) (more preferably the organic silane compound (A-2), and further preferably the organic silane compound (A-3)). In the case where the “nanofibers formed of a polymer of a self-assembly compound” are formed of the fiber-shaped organic silica, the thin film in which nanofibers are oriented and aggregated in the longitudinal direction is formed of an organic silica thin film which is cut products of the polymeric nanofiber aggregate having the fiber-shaped organic silica as a structural unit (polymeric nanofibers) (hereinafter sometimes referred to simply as an “organic silica thin film”). Such a fiber-shaped organic silica formed of a polymer of the organic silane compound (A-1) contains an organic group having a wavelength of maximum absorption within a wavelength range of 200 to 600 nm (hereinafter sometimes also referred to as a “laser light-absorptive organic group”) and a site capable of hydrogen bond (more preferably an amide bond) in a backbone thereof, owing to the structure of the organic silane compound (A-1). For this reason, in the case where the thin film included in the uniaxially oriented polymeric nanofiber aggregate substrate is the above-described organic silica thin film, and the substrate is used as a laser desorption/ionization mass spectrometry substrate, for example, when a measurement sample is prepared by adding dropwise a sample solution containing a molecule to be measured (a highly hydrophilic compound or the like of a biologically relevant molecule or the like) onto a thin film portion of the substrate, the molecule to be measured such as a biologically relevant molecule is easily adsorbed and supported on the hydrogen bond site (preferably an amide bond site). Here, in the fiber-shaped organic silica, a structure in which the hydrogen bond site (site functioning as an adsorption site of the molecule to be measured) is uniformly dispersed is formed owing to the structure of the organic silane compound (A-1), so that the molecule to be measured is supported in a state of being uniformly and highly dispersedly dispersed in the thin film. In addition, in the thin film, since a structure in which the laser light-absorptive organic group is also uniformly dispersed like the hydrogen bond site is formed owing to the structure of the organic silane compound (A-1), when the measurement sample is irradiated with laser light, it is possible to efficiently absorb the laser light at the portions of the organic group, so that the energy of the laser light can be efficiently used without using a matrix. As described above, when the thin film is the organic silica thin film, it is possible to uniformly support the molecule to be measured in a state of being sufficiently and highly dispersedly dispersed, and it is also possible to efficiently use the energy of laser light by causing the laser light to be absorbed in the thin film itself. For this reason, it is possible to efficiently conduct laser desorption/ionization mass spectrometry on a molecule to be measured without using a matrix even in the case where a measurement sample having a low concentration of the molecule to be measured is used.

On the other hand, if attention is paid on the conventional technique as described in NPL 2, it has been necessary to add a matrix for detecting an angiotensin I having a molecular weight of around 1300 at a low concentration in this technique (in the same manner as in a general MALDI method). In this way, using a conventional substrate as described in NPL 2, it has been difficult to conduct a highly sensitive analysis by using a molecule to be measured at a low concentration without using a matrix. Note that in the case where a matrix is used, there is also a case where a signal derived from the matrix is observed as an interference peak in a low molecular weight region. In contrast, in the case where the thin film included in the uniaxially oriented polymeric nanofiber aggregate substrate is the organic silica thin film, it is possible to conduct laser desorption/ionization mass spectrometry on a molecule to be measured without using a matrix even when a measurement sample in which the molecule to be measured has a low concentration is used. For this reason, it is possible to conduct analysis with higher precision for mass spectrometry in a low molecular weight region. From such a viewpoint, the above-described thin film included in the above-described uniaxially oriented polymeric nanofiber aggregate substrate used for laser desorption/ionization mass spectrometry substrate is preferably the above-described organic silica thin film (a thin film including a fiber-shaped organic silica formed of a polymer of the organic silane compound (A-1) as the polymeric nanofibers).

Note that in general, in order to cause a thin film substrate to exert an excellent optical function or electronic function, the formation of a surface nano structure is important in addition to its material. In particular in the field of substrates used in laser desorption/ionization mass spectrometry, it is preferable that such conditions are satisfied that (i) light can be efficiently absorbed, (ii) the energy absorbed can be efficiently transmitted to the molecule to be analyzed adsorbed in the surface of the substrate, and (iii) the molecule which has received the energy can be promptly vaporized and ionized to be emitted to the outside of the substrate because it is considered that highly sensitive analysis can be conducted. From such viewpoints, in the case where the above-described uniaxially oriented polymeric nanofiber aggregate substrate having a pillar array structure (nano concave-convex structure) in which polymeric nanofibers are oriented perpendicularly to the surface of the substrate comprises the above-described organic silica thin film, it is considered that mass spectrometry with a higher sensitivity becomes possible. Moreover, since it is not so practical to re-use a substrate having a nano-scale surface concave-convex structure by washing the substrate after the use, a substrate which has such a structure for laser desorption/ionization mass spectrometry is assumed to be a disposable substrate, but the above-described uniaxially oriented polymeric nanofiber aggregate substrate can be produced continuously at high speed and at low cost although the uniaxially oriented polymeric nanofiber aggregate substrate is a substrate having a nano porous structure in which polymeric nanofibers are homogenously oriented. Hence, the present invention is advantageous in that it becomes possible to achieve mass production of substrates, an increase in speed and reduction in cost of producing substrates, and the like by using the uniaxially oriented polymeric nanofiber aggregate substrate or a hydrophobized product thereof as substrates for laser desorption/ionization mass spectrometry as in the present invention.

In addition, the hydrophobized product that can be used in the laser desorption/ionization mass spectrometry substrate of the present invention is obtained by conducting a hydrophobization treatment on the uniaxially oriented polymeric nanofiber aggregate substrate of the present invention. The method for such hydrophobization treatment is not particularly limited, and a publicly-known method that can introduce a hydrophobic group into the thin film included in the uniaxially oriented polymeric nanofiber aggregate substrate can be employed as appropriate.

Note that such a hydrophobic group is not particularly limited, and is not particularly limited as long as the group is capable of adding hydrophobicity, and includes, for example, an alkyl group, an alkynyl group, an alkenyl group, a fluorine atom-containing group, groups containing halogen atoms other than a fluorine atom, an alkoxy group, an aromatic ring, and the like. Among these, an alkyl group, a fluoroalkyl group, and a phenyl group are preferable, and an alkyl group and a fluoroalkyl group are particularly preferable from the viewpoint that it becomes possible to promote desorption of a molecule to be measured while enabling the molecule to be measured to be supported at a high density on the surface of the thin film.

Particularly favorable alkyl groups as such a hydrophobic group include a methyl group, an ethyl group, a propyl group, a butyl group, a pentyl group, a hexyl group, a heptyl group, an octyl group, a cyclohexyl group, and the like. In addition, particularly favorable fluoroalkyl groups as the hydrophobic group include perfluoroalkyl groups obtained by substituting all hydrogen atoms with fluorine atoms, such as a trifluoromethyl group (CF₃—), a pentafluoroethyl group (CF₃—CF₂—), and a heptafluoropropyl group (CF₃—CF₂—CF₂—); fluoroalkyl groups obtained by substituting at least some of hydrogen atoms with fluorine atoms such as a 2,2,2-trifluoroethyl group (CF₃—CH₂—), a 3,3,3-trifluoropropyl group (CF₃—CH₂—CH₂—), a 2,2,3,3,3-pentafluoropropyl group (CF₃—CF₂—CH₂—), a 3,3,4,4,4-pentafluorobutyl group (CF₃—CF₂—CH₂—CH₂—), a 3,3,4-trifluorobutyl group (F—CH₂—CF₂—CH₂—CH₂—), and a 1H,1H,2H,2H-nonafluorohexyl group (CF₃—CF₂—CF₂—CF₂—CH₂—CH₂—); and the like.

In addition, as such a method for hydrophobization treatment, in the case where the thin film included in the uniaxially oriented polymeric nanofiber aggregate substrate is the above-described organic silica thin film, a method that introduces a hydrophobic group by bringing an organic silane compound containing a hydrophobic group into contact with the organic silica thin film (hereinafter this method is sometimes referred to simply as a “method (a)”) can be employed. Hereinafter, this method (a) will be briefly described.

Such a method (a) uses an organic silane compound (B-1) containing a hydrophobic group. As the hydrophobic group contained in such an organic silane compound, the same as those of the aforementioned hydrophobic groups can be favorably used. When the organic silane compound (B-1) containing a hydrophobic group is brought into contact with the organic silica thin film, a silicon atom of a siloxane bond contained in the organic silica thin film and a silyl group of the organic silane compound containing the hydrophobic group react to obtain an organic silica thin film further containing the hydrophobic group. The method for bringing the organic silane compound (B-1) containing a hydrophobic group into contact with the organic silica thin film is not particularly limited, and includes, for example, conventionally known methods such as a method that applies a solution containing the organic silane compound (B-1) to the organic silica thin film, a method that immerses the organic silica film into a solution containing the organic silane compound (B-1), and a method that exposes the organic silica film to a vapor of the organic silane compound (B-1). Such an organic silane compound (B-1) containing a hydrophobic group includes, for example, an alkyl silane compound, an alkynylsilane compound, an alkenylsilane compound, a fluorine atom-containing silane compound, silane compounds containing halogen atoms other than a fluorine atom, an alkoxy-silane compound, an aromatic ring-containing silane compound, and the like.

Note that the organic silica thin film obtained by the method (a) is an organic silica thin film in the form that the organic silica thin film has a laser light-absorptive organic group and a hydrogen bond site (preferably an amide bond site) in a backbone thereof, and a hydrophobic group further binds to a silicon atom of a siloxane bond in the backbone. Here, the hydrogen bond site and the laser light-absorptive organic group are sites introduced into the backbone of the thin film owing to the structure in the self-assembly compound, and the backbone of the thin film is formed by polymerization of the self-assembly compound. For this reason, the laser light-absorptive organic group and the hydrogen bond site are sufficiently uniformly dispersed and arranged in the organic silica thin film. Then, once a hydrophobic group is introduced into such an organic silica thin film by the method (a), an amide group and the hydrophobic group are arranged in the surface of the organic silica film uniformly in a well-balanced manner. In addition, in the case where a measurement sample is prepared by adding dropwise a sample solution containing a molecule to be measured which is formed of a highly hydrophilic compound such as a biologically relevant molecule onto the surface of the organic silica thin film into which a hydrophobic group has been introduced, it is possible to adsorb and support the highly hydrophilic compound onto the hydrogen bond site (a site having an amide bond or the like) while concentrating the sample solution due to the action of the hydrophobic group. Hence, the highly hydrophilic compound (the molecule to be measured) is uniformly and highly dispersedly supported on the surface of the organic silica thin film. Then, it is considered that when laser desorption/ionization mass spectrometry is conducted by using a measurement sample formed of an organic silica thin film on which a highly hydrophilic compound (molecule to be measured) is highly dispersedly supported, the laser light-absorptive organic group (which is obviously dispersed and arranged together with the hydrogen bond site near the hydrogen bond site) in the organic silica thin film absorbs laser light and makes it possible to efficiently transmit the absorbed energy to the highly hydrophilic compound (the molecule to be measured) adsorbed and supported on the hydrogen bond site in the surface of the thin film; also, since desorption of the highly hydrophilic compound is promoted by the hydrophobic group reducing interaction between the surface of the organic silica thin film and the highly hydrophilic compound, it is possible to cause desorption and ionization of the highly hydrophilic compound to more efficiently proceed, and also a signal corresponding to the highly hydrophilic compound can be detected from the entire surface of the organic silica thin film, so that it becomes possible to more uniformly detect the highly hydrophilic compound with higher sensitivity.

As described above, from the viewpoint that it becomes possible to obtain the action of promoting the desorption of the highly hydrophilic compound due to the hydrophobic group and to conduct mass spectrometry with higher sensitivity, as the laser desorption/ionization mass spectrometry substrate of the present invention, it is preferable to use a hydrophobized product of a uniaxially oriented polymeric nanofiber aggregate substrate, and especially, it is particularly preferable to use a hydrophobized product of a uniaxially oriented polymeric nanofiber aggregate substrate including the above-described organic silica thin film as a thin film.

Here, a preferred method for the laser desorption/ionization mass spectrometry method using the laser desorption/ionization mass spectrometry substrate of the present invention will be described. Such a laser desorption/ionization mass spectrometry method is a method including: preparing a measurement sample by causing a molecule to be measured to be supported on the laser desorption/ionization mass spectrometry substrate of the present invention; and irradiating the measurement sample with laser light to desorb the molecule to be measured from the organic silica substrate and ionize the molecule to be measured to conduct mass spectrometry.

In such a laser desorption/ionization mass spectrometry method, first, a sample to be measured in the laser desorption/ionization mass spectrometry (a sample containing a molecule to be measured) is supported on the laser desorption/ionization mass spectrometry substrate of the present invention. Next, the substrate (the measurement sample) supporting the sample containing the molecule to be measured is irradiated with laser light. This makes it possible to desorb the molecule to be measured from the substrate and ionize the molecule to be measured to conduct mass spectrometry.

In addition, the sample containing a molecule to be measured to which such a laser desorption/ionization mass spectrometry method can be applied is not particularly limited, but biologically relevant molecules such as amino acids, proteins, sugars, phospholipids, hormones, nucleic acids, and metabolites of these are suitable from the viewpoint that it becomes possible to conduct analysis with higher sensitivity.

In addition, the laser light used in such a laser desorption/ionization mass spectrometry method is not particularly limited and includes, for example, nitrogen laser (wavelength: 337 nm), YAG laser third harmonic wave (wavelength: 355 nm), NdYAG laser (wavelength: 256 nm), carbon dioxide gas laser (wavelength: 9400 nm and 10600 nm), and the like. The irradiation conditions (irradiation intensity, irradiation time, and the like) for the laser light are not particularly limited and may be set by selecting the most suitable conditions from publicly-known mass spectrometry conditions depending on the molecule to be measured as appropriate.

Moreover, the method for separating and detecting ions for mass spectrometry in the above-described laser desorption/ionization mass spectrometry method is not particularly limited, and a double-focusing method, a quadrupole focusing method (a quadrupole (Q) filter method), a tandem quadrupole (QQ) method, an ion trap method, a time-of-flight (TOF) method, or the like may be employed.

By employing such a laser desorption/ionization mass spectrometry method, it becomes possible to efficiently conduct laser desorption/ionization mass spectrometry by using the laser desorption/ionization mass spectrometry substrate of the present invention.

### EXAMPLES

Hereinafter, the present invention will be described more specifically based on Examples and Comparative Examples; however, the present invention is not limited to the following Examples.

### <Synthesis of Self-assembly Compounds>

### Synthesis Example 1

First, 1,8-naphthalic anhydride (5.95 g, 30.0 mmol, a compound represented by the following formula (1)), pyridine (60 ml), and ethylenediamine (60 ml) were mixed under a nitrogen atmosphere, and a mixture thus obtained was stirred while heated at 110° C. for 72 hours to conduct reaction represented by the following reaction formula (I):

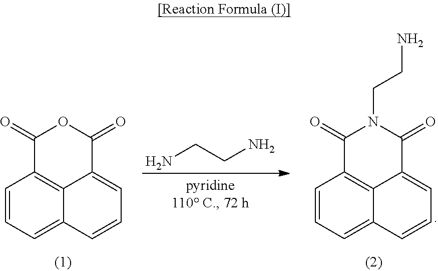

After most of pyridine and ethylenediamine was removed from a solution thus obtained by using a rotary evaporator, a residue was recrystallized by using cold acetonitrile. A crystal thus obtained was collected by suction filtration, followed by vacuum drying to obtain a solid component (yield amount: 5.10 g, yield rate: 71%).

The obtained solid component was dissolved in deuterochloroform (CDCl₃), and ¹H-NMR spectrum was measured and identified by using an NMR measurement device (“JNM-ECX400P” manufactured by JEOL Ltd.) and it was confirmed to be N-(2-aminoethyl)-1,8-naphthalimide (a compound represented by the above-described formula (2)). The result is shown below.

¹H-NMR (CDCl₃, δ in ppm): 3.08 (t, J=6.6 Hz, 2H), 4.29 (t, J=6.6 Hz, 2H), 7.76 (m, 2H), 8.22 (m, 2H), 8.61 (m, 2H).

Next, N-(2-aminoethyl)-1,8-naphthalimide (2.40 g, 10.0 mmol), succinic acid (0.53 g, 4.50 mmol), 4-dimethylaminopyridine (DMAP, 48.9 mg, 0.40 mmol), and dichloromethane (40 ml) were mixed under a nitrogen atmosphere, and 1-ethyl-3-(3-dimethylaminopropyl) carbodiimide hydrochloride (EDC, 3.50 g, 18.3 mmol) was further added, and a mixture thus obtained was stirred at room temperature for 3 days to conduct reaction represented by the following reaction formula (II):

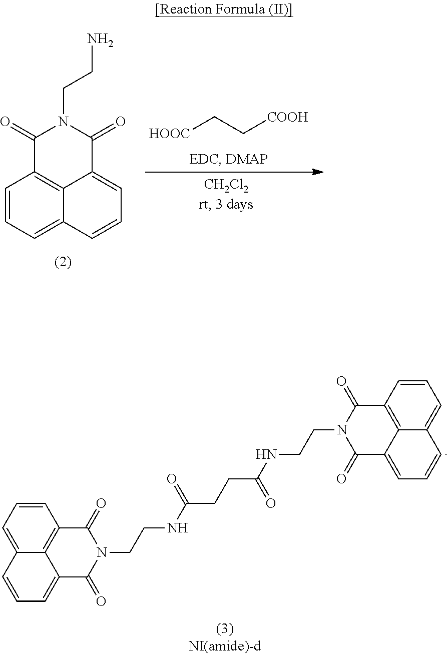 [SMILES: NCCN1C(=O)c2cccc3cccc(c23)C1=O ; O=C(O)CCC(=O)O ; O=C(CCC(=O)NCCN1C(=O)c2cccc3cccc(c23)C1=O)NCCN1C(=O)c2cccc3cccc(c23)C1=O]

To a suspension thus obtained, ethanol (150 ml) was added, followed by stirring for 1 hour, and then an insoluble solid component is collected by suction filtration. This solid component was dispersed in acetonitrile again, followed by stirring while heating at 70° C. for 5 minutes. A suspension thus obtained was cooled to room temperature, and then an insoluble solid component was collected by suction filtration, followed by vacuum drying (yield amount: 1.81 g, yield rate: 71%).

A solid component thus obtained was dissolved in deuterated dimethylsulfoxide (DMSO-d₆), and ¹H-NMR spectrum was measured and identified by using an NMR measurement device (“JNM-ECX400P” manufactured by JEOL Ltd.) and it was confirmed to be a compound represented by the above-described formula (3) (a dimer of naphthalimide to which an amide group bound: hereinafter sometimes referred to simply as “NI (amide)-d”). The result is shown below. Note that it was considered that one of peaks of methylene overlapped a peak (5 to 3.3 ppm) of DMSO.

¹H-NMR (DMSO-d₆, δ in ppm): 2.06 (s, 4H), 4.10 (m, 4H), 7.85 (m, 4H), 7.91 (m, 2H), 8.45 (m, 8H).

Next, NI (amide)-d (the compound represented by the above-described formula (3), 0.62 g, 1.10 mmol), carbonyldihydridotris(triphenylphosphine)ruthenium [RuH₂(CO) (PPh₃)₃] (55.1 mg, 0.06 mmol), and dimethylacetamide (DMAc, 20 ml) were mixed under a nitrogen atmosphere, and triisopropoxyvinylsilane (2.35 ml, 2.05 g, 8.80 mmol) was further added, and a mixture thus obtained was stirred while heated at 160° C. for 3 hours to conduct reaction represented by the following reaction formula (III):

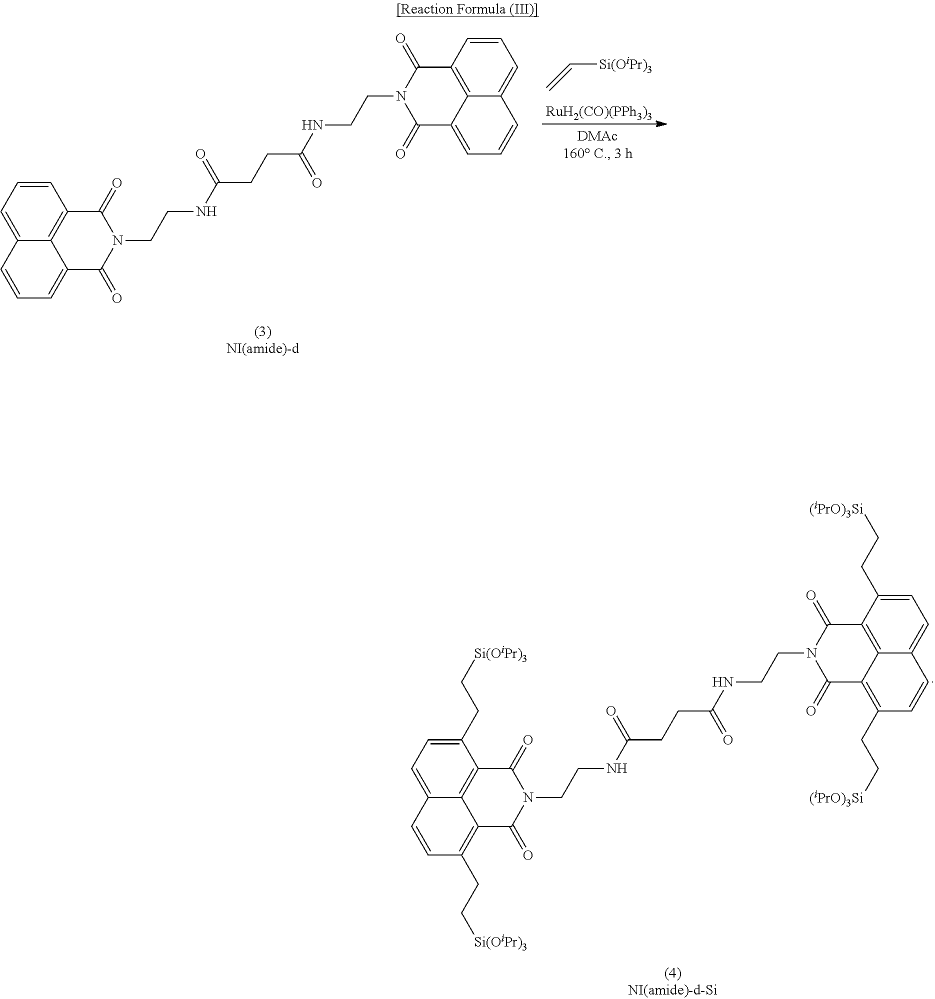

After most of DMAc was removed from a solution thus obtained by using a rotary evaporator, a residue was mixed with ethyl acetate (10 ml), and hexane (150 ml) was further added. A mixture thus obtained was cooled in a refrigerator for 12 hours. A crystal thus obtained was collected by suction filtration, and washed with cold hexane, followed by vacuum drying to obtain a solid component (yield amount: 1.22 g, yield rate: 74%). Note that when part of the obtained solid component was used and mixed with water and then recollected, followed by vacuum drying, an amount of change in mass of the solid component between before and after mixing with water was 0.1% by mass or less of the mass before mixing with water (an amount which could be regarded as almost 0). Hence, it was confirmed that the obtained solid component was a water-insoluble component.

In addition, the obtained solid component was dissolved in deuterochloroform (CDCl₃), and ¹H-NMR spectrum was measured and identified by using an NMR measurement device (“JNM-ECX400P” manufactured by JEOL Ltd.) and it was confirmed to be a compound represented by the above-described formula (4), which was a reaction product of a dimer of naphthalimide to which an amide group bound and triisopropoxyvinylsilane (hereinafter sometimes referred to as “NI (amide)-d-Si”). The result is shown below.

¹H-NMR (CDCl₃, δ in ppm): 1.03 (m, 8H), 1.23 (d, J=6.0 Hz, 72H), 2.40 (s, 4H), 3.50 (m, 12H), 4.28 (m, 12H), 4.34 (m, 4H), 6.69 (bs, 2H), 7.53 (d, J=8.4 Hz, 4H), 7.99 (d, J=8.4 Hz, 4H).

### <Production of Polymeric Nanofiber Aggregate and Uniaxially Oriented Polymer Nanofiber Aggregate Substrate>

The structures and the like of the polymeric nanofiber aggregates and uniaxially oriented polymeric nanofiber aggregate substrates obtained in Examples and the like described below were measured as follows.

### <Evaluation of State and the Like of Aggregate (SEM Observation)>

The oriented state and the like of nanofibers in a polymeric nanofiber aggregate and a uniaxially oriented polymeric nanofiber aggregate substrate were observed and evaluated by using a scanning electron microscope (SEM: “SU3500” manufactured by HITACHI).

### <Confirmation of Polycondensation of Self-assembly Compound>

The proceeding of polycondensation of a self-assembly compound (analysis of the cross-linking state) was analyzed by measuring solid-state ²⁹Si MAS NMR spectrum. For the measurement, “AVANCE 400” manufactured by Bruker was used as a measuring device.

### Example 1

### <Steps of Producing Polymeric Nanofiber Aggregate>

NI(amide)-d-Si (the compound represented by the above-described formula (4), 0.5 g) obtained in Synthesis Example 1 was added to a mixed solvent (24.5 g) containing ethanol and water in a mass ratio ([ethanol]:[water]) of 4:1 to obtain a mixed liquid having a concentration of NI (amide)-d-Si of 2 wt %. Next, the obtained mixed liquid was heated to 80° C. to dissolve NI (amide)-d-Si in the mixed solvent, which was put into a square glass pipe (30×30×100 mm) with one end sealed, followed by cooling to room temperature (about 25° C.) to form a gel-like composition in the square glass pipe. Thereafter, the sealing of the square glass pipe was removed and the gel-like composition was slowly taken out to take out the composition from the glass pipe while maintaining the gel state, so that a gel composition having a cuboid shape of a longitudinal side of 30 mm, a lateral side of 30 mm, and a height of 35 mm was obtained.

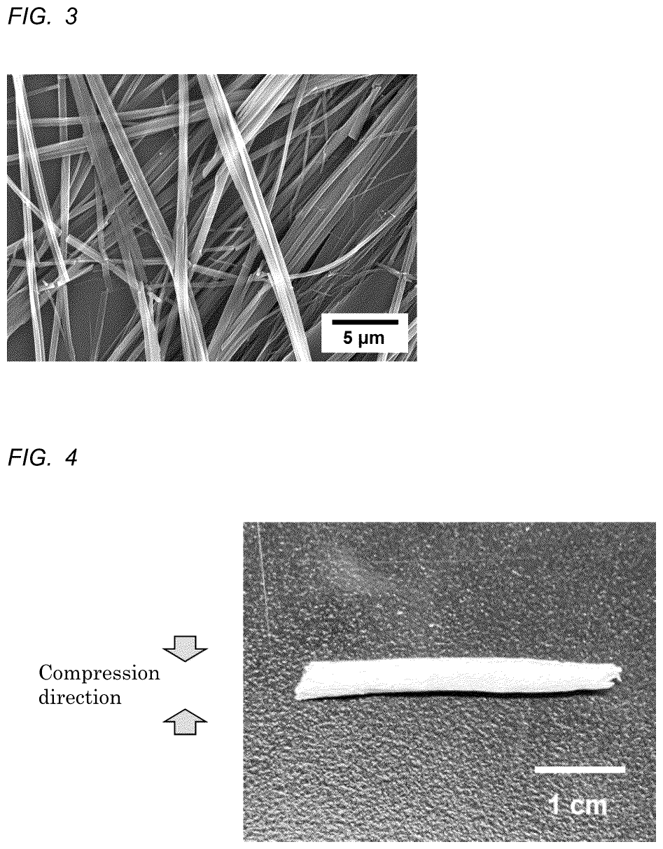

Note that in order to check the state of NI(amide)-d-Si in the gel-like composition obtained in this way, SEM observation was conducted. The result thus obtained is shown in FIG. 3. As is clear from the result shown in FIG. 3, as a result of observation with SEM, it was confirmed that nanofiber-shaped molecular assembly having a width of around 300 to 800 nm was randomly aggregated in the gel-like composition, so that a net-shaped structural article was formed. In addition, from the result shown in FIG. 3, it was confirmed that NI(amide)-d-Si formed the fiber-shaped molecular assembly through self-assembly, and it was confirmed that the gel-like composition was a complex of the mixed solvent and the nanofiber-shaped molecular assembly.

Next, the gel composition having a cuboid shape (the complex of the mixed solvent and the nanofiber-shaped molecular assembly) produced as mentioned above was immersed into 1 L of water for 3 days to replace ethanol contained in the gel with water, thus forming a water-replaced gel-like composition (a complex (gel) composed of water and the nanofiber-shaped molecular assembly).

Subsequently, the water-replaced gel-like composition (having a cuboid shape of a longitudinal side of 30 mm, a lateral side of 30 mm, and a height of 35 mm) thus obtained was taken out from water. Thereafter, the water-replaced gel-like composition having a cuboid shape is compressed in two directions, that is, the vertical direction and the lateral direction, while the water-replaced gel-like composition is set free in the height direction, to make the shape of the water-replaced gel-like composition into a substantially rectangular column-shape. Subsequently, the substantially rectangular column-shaped water-replaced gel-like composition (after squeeze) was dried under conditions of 120° C. and 3 hours to obtain a substantially rectangular column-shaped solid having a section of a longitudinal side: about 5 mm and a lateral side: about 5 mm. An external appearance image of the substantially rectangular column-shaped solid thus obtained (in the state of an aggregate in which the nanofibers were aggregated) is shown in FIG. 4 while the directions of compression is conceptually and clearly shown.

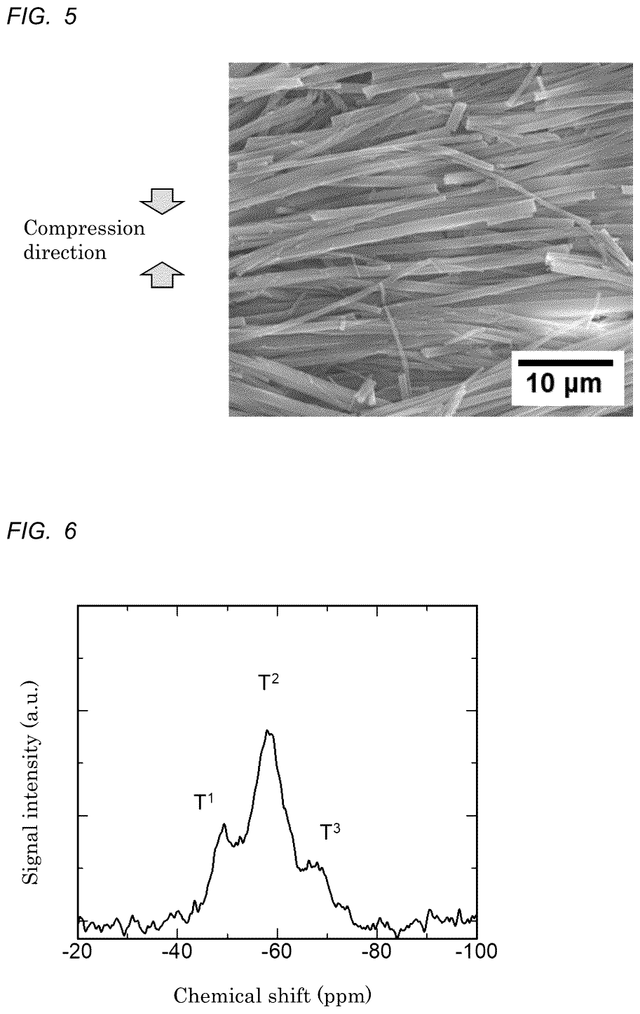

Note that SEM observation was conducted to check the state of the substantially rectangular column-shaped solid thus obtained. An electron microscopic image (SEM image) obtained by such measurement is shown in FIG. 5. As is clear from the result shown in FIG. 5, it was confirmed that the substantially rectangular column-shaped solid thus obtained had nanofiber-shaped molecular assembly oriented in a direction perpendicular to the compression direction (the longitudinal direction) and had a structure in which the fibers were bundled, and was found to be a bundle-shaped nanofiber assembly (hereinafter referred to as a “nanofiber bundle”).

Next, the nanofiber bundle (substantially rectangular column-shaped solid) obtained as mentioned above was exposed to a vapor of 2M hydrochloric acid under a temperature condition of 100° C. for 3 hours to polycondensate the NI(amide)-d-Si (self-assembly compound) in the bundle to obtain a polymeric nanofiber aggregate containing nanofibers formed of an organic silica (a polymer of NI(amide)-d-Si). Note that the proceeding of the polycondensation of NI(amide)-d-Si was confirmed by detecting a signal of Tⁿ species (Tⁿ: —Si(OSi)ₙ(OH)₃₋ₙ) in the ²⁹Si MAS NMR spectrum. The graph of the ²⁹Si MAS NMR spectrum of the polymeric nanofiber aggregate obtained by such measurement is shown in FIG. 6. From the result shown in FIG. 6, it was found that in the polymeric nanofiber aggregate, the polycondensation reaction of NI(amide)-d-Si proceeded, so that the nanofibers were formed of the organic silica (the polymer of NI(amide)-d-Si).

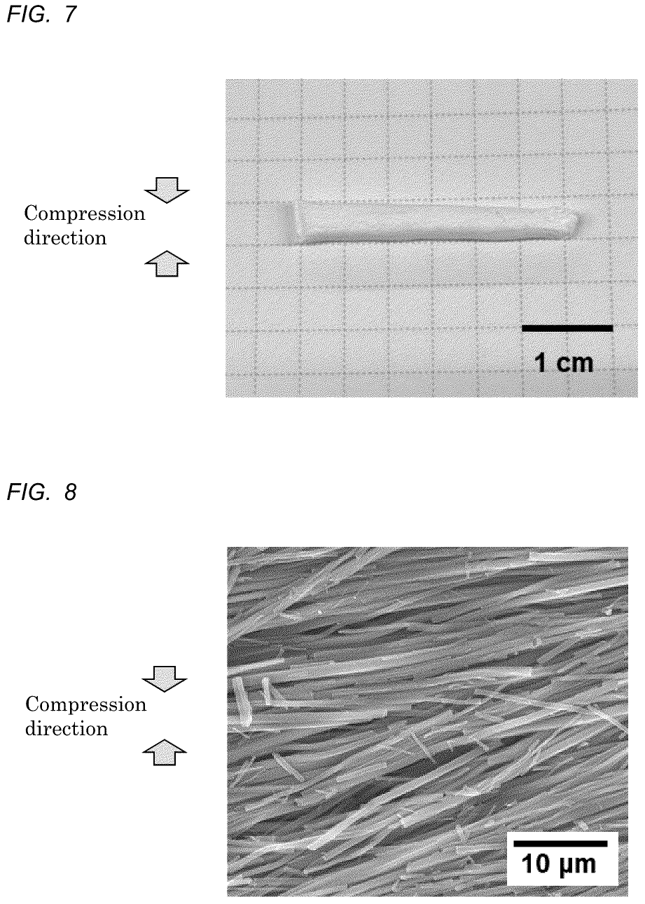

In addition, an external appearance image of the state of the polymeric nanofiber aggregate (the organic silica nanofiber bundle) (the state of fibers) is shown in FIG. 7 while the directions of compression are conceptually and clearly shown. In addition, SEM observation was conducted in order to check the state of the aggregate of the polymeric nanofibers thus obtained. The electron microscopic image (SEM image) obtained by such measurement is shown in FIG. 8. From the result shown in FIG. 8, it was confirmed that the nanofibers formed of the organic silica are oriented in the vertical direction (the longitudinal direction) perpendicular to the directions of compression, and it was confirmed that the nanofibers were able to be polymerized and fixed while the orientation structure of the self-assembly nanofiber bundle was sufficiently maintained without causing a large morphological change due to the polycondensation. Note that the nanofibers included in such a polymeric nanofiber aggregate were those having an average diameter and an average length of 550 nm (average diameter) and 70 μm (average length), respectively, which were obtained as an average value of 50 nanofibers randomly selected through SEM observation.

### <Steps of Producing Uniaxially Oriented Polymer Nanofiber Aggregate Substrate>

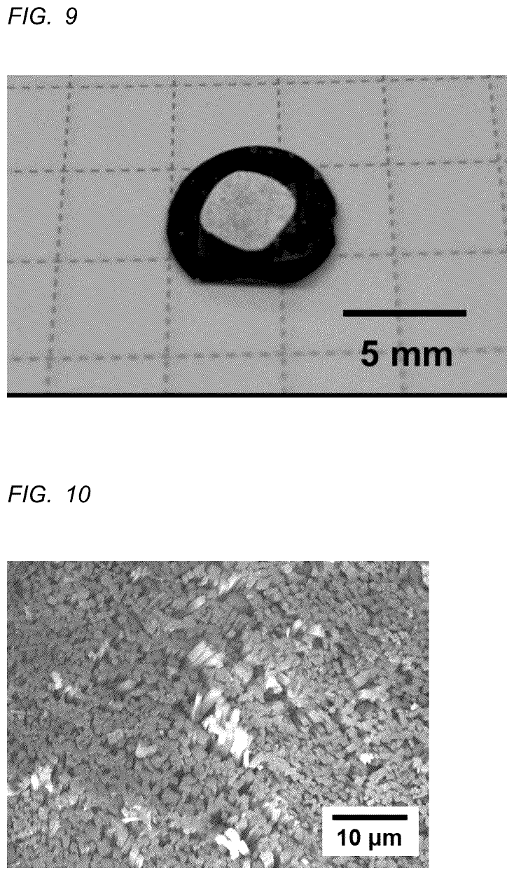

After the periphery of the polymeric nanofiber aggregate (the organic silica nanofiber bundle) obtained as mentioned above was covered to be solidified and reinforced with an epoxy resin (“Crystal Resin NEO” produced by NISSIN RESIN Co., Ltd.), the polymeric nanofiber aggregate was cut in a substantially vertical direction relative to the orientation direction (the longitudinal direction) of the nanofibers into a thickness of 20 μm to obtain a piece by using a rotary microtome HM360 (Microedge). Then, the piece was fixed onto a carbon seal (support) to obtain a substrate (a uniaxially oriented polymeric nanofiber aggregate substrate: a thin film substrate) including an organic silica thin film formed of nanofibers composed of the organic silica (the polymer of NI(amide)-d-Si). The image showing the state (external appearance) of the organic silica thin film thus obtained is shown in FIG. 9.

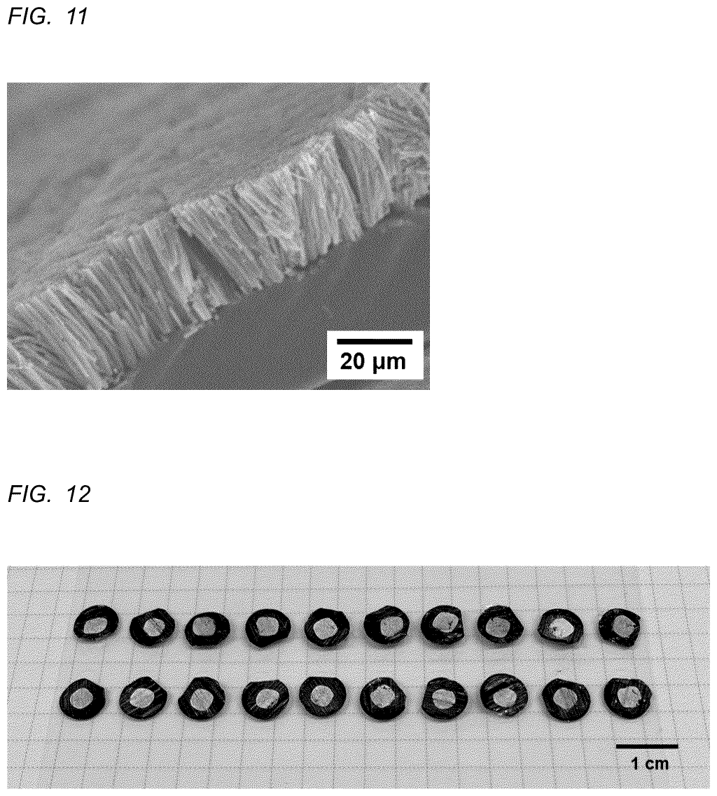

In addition, in order to check the structure of the obtained thin film, SEM observation was conducted for the surface and the section of the thin film. The electron microscopic image (SEM image) of the surface of the thin film is shown in FIG. 10, and the electron microscopic image (SEM image) of the section of the thin film is shown in FIG. 11. As is clear from the results shown in FIGS. 10 to 11 as well, it was confirmed from the SEM observation that the thin film (the organic silica thin film) thus obtained was a porous thin film (a vertically oriented porous thin film of the organic silica nanofibers) having a structure (a pillar array structure of the nanofibers: a nano concave-convex structure) in which cut products (columnar bodies) of the nanofibers of the organic silica were vertically oriented (oriented in one direction). It was thus confirmed that the uniaxially oriented polymeric nanofiber aggregate substrate including a thin film in which the nanofibers of the organic silica were oriented and aggregated in one direction relative to the surface of the substrate was obtained by the above-described steps. Note that in the obtained porous thin film, an average interval between polymeric nanofibers (an average distance obtained by obtaining distances among the closest nanofibers for 50 nanofibers randomly selected through SEM observation) was 1.8 times the average diameter of the polymeric nanofibers.

In addition, a plurality of substrates having the same structure were continuously produced by conducting the step of cutting the polymeric nanofiber aggregate (the organic silica nanofiber bundle) into a thickness of 20 μm. Images of the plurality of thin films thus obtained are shown in FIG. 12.

### Example 2

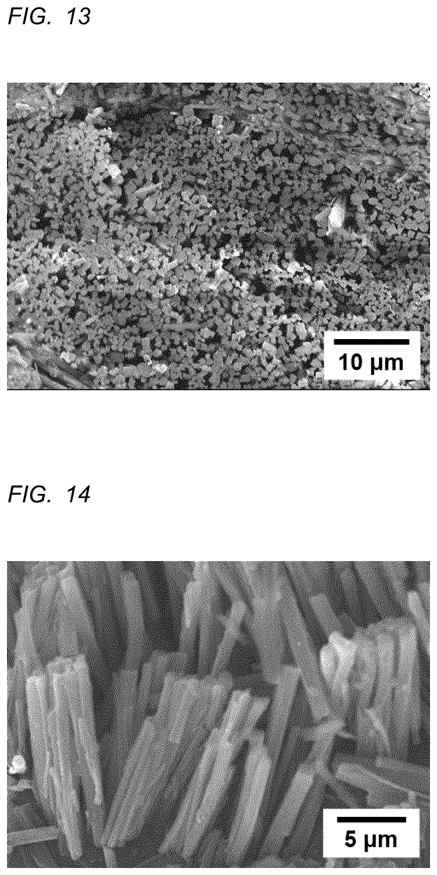

A substrate (a uniaxially oriented polymeric nanofiber aggregate substrate) including an organic silica thin film formed of nanofibers composed of the organic silica (the polymer of NI(amide)-d-Si) was obtained in the same manner as in Example 1 except that the thickness to be cut was changed from 20 μm to 10 μm in the steps of producing a uniaxially oriented polymeric nanofiber aggregate substrate. In order to check the structure of the thin film thus obtained, SEM observation was conducted for the surface and the section of the thin film. The electron microscopic image (SEM image) of the surface of the thin film is shown in FIG. 13, and the electron microscopic image (SEM image) of the section of the thin film is shown in FIG. 14. As is clear from the results shown in FIGS. 13 to 14 as well, it was confirmed from the SEM observation that the thin film (the organic silica thin film) thus obtained was a porous thin film (a vertically oriented porous thin film of an organic silica nanofibers) having a structure in which cut products (columnar bodies) of the nanofibers of the organic silica were vertically oriented (oriented in one direction). It was thus confirmed that the uniaxially oriented polymeric nanofiber aggregate substrate including a thin film in which the nanofibers of the organic silica were oriented and aggregated in one direction relative to the surface of the substrate was obtained by the above-described steps.

### Example 3

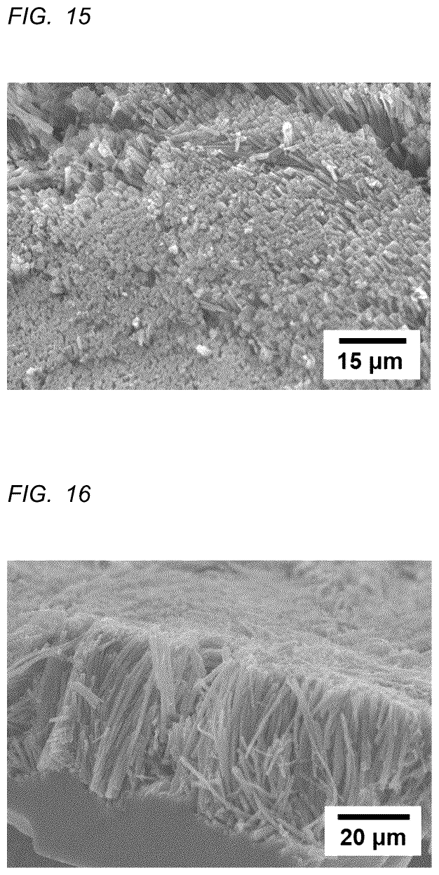

A substrate (a uniaxially oriented polymeric nanofiber aggregate substrate) including an organic silica thin film formed of nanofibers composed of the organic silica (the polymer of NI(amide)-d-Si) was obtained in the same manner as in Example 1 except that the thickness to be cut was changed from 20 μm to 30 μm in the steps of producing a uniaxially oriented polymeric nanofiber aggregate substrate. In order to check the structure of the obtained thin film, SEM observation was conducted for the surface and the section of the thin film. The electron microscopic image (SEM image) of the surface of the thin film is shown in FIG. 15, and the electron microscopic image (SEM image) of the section of the thin film is shown in FIG. 16. As is clear from the results shown in FIGS. 15 to 16 as well, it was confirmed from the SEM observation that the thin film (the organic silica thin film) thus obtained was a porous thin film (a vertically oriented porous thin film of the organic silica nanofibers) having a structure in which cut products (columnar bodies) of the nanofibers of the organic silica were vertically oriented (oriented in one direction). It was thus confirmed that the uniaxially oriented polymeric nanofiber aggregate substrate including a thin film in which the nanofibers of the organic silica were oriented and aggregated in one direction relative to the surface of the substrate was obtained by the above-described steps.

From such results shown in Examples 1 to 3, it was confirmed that it became possible to conduct such processing that the orientation direction of nanofibers became one direction by forming a nanofiber structural article in a mixed solvent containing an organic solvent through self-assembly to obtain a gel-like composition, and then replacing the organic solvent with water, and further it became possible to continuously and efficiently produce a porous substrate (a uniaxially oriented polymeric nanofiber aggregate substrate) in which nanofibers are vertically oriented by fixing a bundle composed of the nanofibers oriented in one direction through polycondensation, and then cutting (slicing) the bundle.

### Comparative Example 1

NI(amide)-d-Si (the compound represented by the above-described formula (4), 40 mg) obtained in Synthesis Example 1 was added to a mixed solvent (1.96 g) containing ethanol and water in a mass ratio ([ethanol]:[water]) of 4:1 to obtain a mixed liquid having a concentration of NI (amide)-d-Si of 2 wt %. Next, the obtained mixed liquid was heated to 80° C. to dissolve NI(amide)-d-Si in the mixed solvent and then cooled to room temperature (about 25° C.) to obtain a gel-like composition. It is obvious from the production method that such a gel-like composition is a complex of the mixed solvent and a nanofiber-shaped molecular assembly formed of NI(amide)-d-Si by referring to Example 1.

Subsequently, sonication was conducted by irradiating the gel-like composition with an ultrasonic wave (42 kHz) for 10 minutes to prepare a dispersion liquid containing self-assembly nanofibers (nanofiber-shaped molecular assembly). Next, the dispersion liquid thus obtained was applied onto a silicon substrate such that the applied amount became 40 μL/cm², followed by drying at room temperature for 24 hours to remove the solvent. Thereafter, the dried film thus obtained was exposed to a vapor of 2M hydrochloric acid under a temperature condition of 100° C. for 3 hours to polycondensate NI (amide)-d-Si in the dried film to obtain a thin film (a substrate) for comparison which contained nanofibers formed of the organic silica (the polymer of NI(amide)-d-Si).

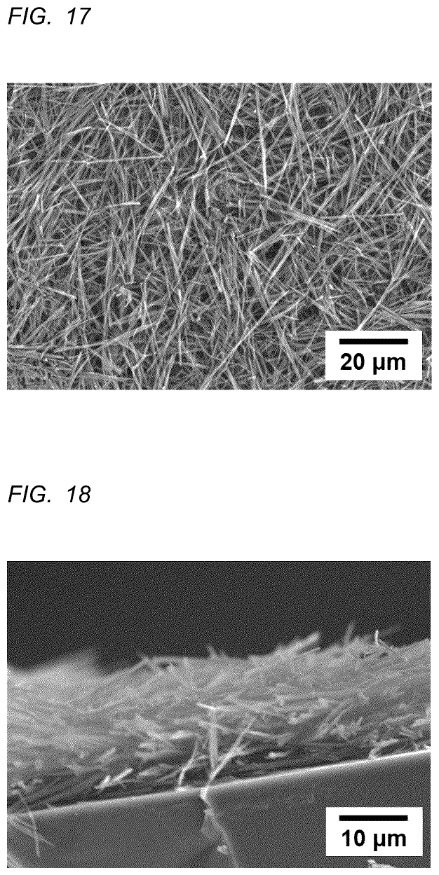

In order to check the structure of the thin film thus obtained, SEM observation was conducted for the surface and the section of the thin film. The electron microscopic image (SEM image) of the surface of the thin film is shown in FIG. 17, and the electron microscopic image (SEM image) of the section of the thin film is shown in FIG. 18. As is clear from the results shown in FIG. 17 to FIG. 18, it was confirmed that the obtained thin film was a thin film in which nanofibers formed of the organic silica (the polymer of NI(amide)-d-Si) were randomly oriented and aggregated in a thickness of 15 to 20 μm. In this way, in Comparative Example 1, a thin film that was oriented in a uniaxial direction was not obtained, and the obtained thin film (substrate) was a thin film formed of randomly oriented organic silica nanofibers.

### Comparative Example 2

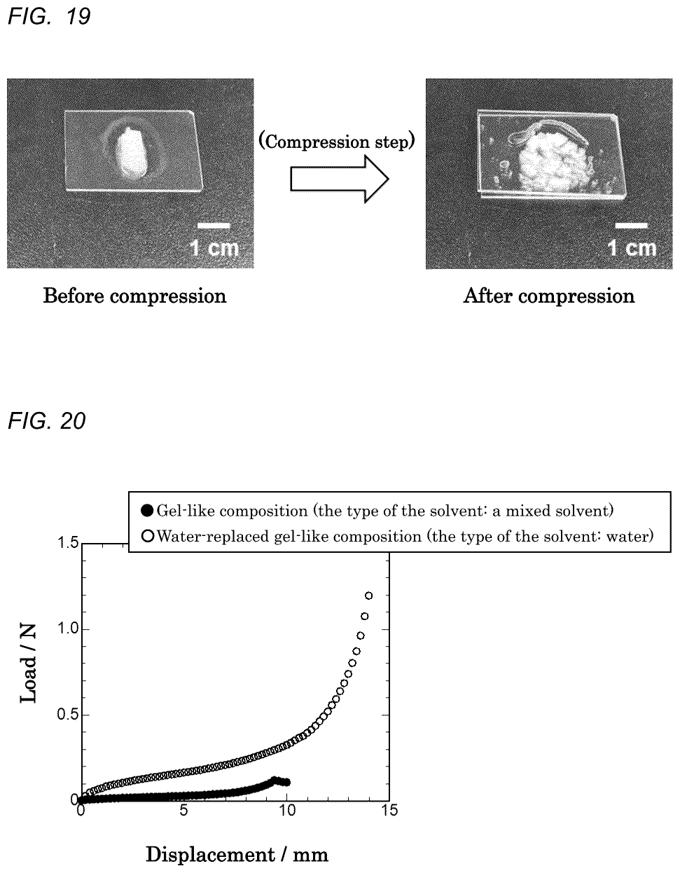

A gel-like composition was produced in the same procedure as in Example 1, and the gel-like composition was used as it was, and part of the gel-like composition was processed into a columnar shape having a diameter of about 1 cm, and the gel-like composition having the columnar shape was compressed by using a glass plate without conducting the step of replacing ethanol with water. As a result, the gel structure of the composition was collapsed. Images showing the states of the gel-like composition before and after the compression are shown in FIG. 19. It was confirmed from the result shown in FIG. 19 that the gel-like composition could not be squeezed by compression, and could not be processed by compressing the gel-like composition while maintaining the gel structure in the case where the organic solvent (ethanol) in the gel-like composition was not replaced with water.

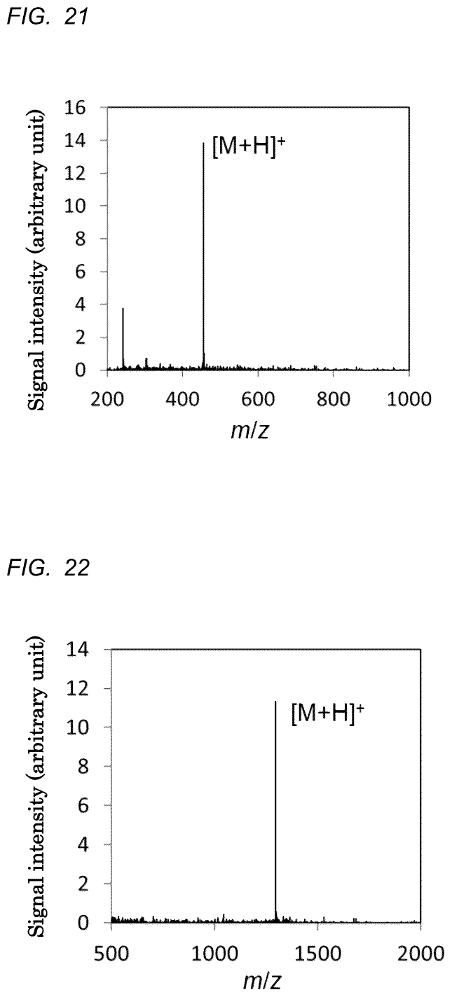

Note that in order to check the collapse of the gel structure in Comparative Example 2 from mechanical data, load-displacement characteristics at the time of compression of a gel-like composition (the type of the solvent: a mixed solvent) and a water-replaced gel-like composition (the type of the solvent: water) were measured. In such a measurement, a gel-like composition which was produced in the same procedure as in Example 1 and then was used as it was and part of which was processed in a columnar shape having a diameter of 1 cm and a height of 1.5 cm (the type of the solvent: a mixed solvent), and a water-replaced gel-like composition which was obtained in the same method as employed in Example 1 and part of which was processed into a columnar shape having a diameter of 1 cm and a height of 1.5 cm (the type of the solvent: water) were prepared. Then, each was used as a column-shaped measurement sample. Then, each measurement sample (column) was compressed by adding a load in the direction of the height of the column at a speed of 1 mm/min to measure the load-displacement characteristic of the sample. The results thus obtained are shown in FIG. 20.

As is clear from the results shown in FIG. 20 as well, it was confirmed that in the case where ethanol in the mixed solvent contained in the gel-like composition was not replaced with water, the load hardly increased even when the displacement was increased, and the load was obviously turned to decrease at a position where the displacement was near 9 mm. Hence, it was also shown from the mechanical data that the gel structure was collapsed by compression in Comparative Example 2. In contrast, in the water-replaced gel-like composition in which the solvent was replaced with water, the load monotonously increased as the displacement was increased, and the load increased to about 1.2 N at the displacement of 14 mm. From such mechanical data, it was also indicated that the strength of self-assembly nanofibers forming a gel was significantly improved by replacing an organic solvent (ethanol) in the gel composition with water. From such results, it was found that after a gel-like composition was obtained as described above, it became possible to process the gel-like composition such that the self-assembly nanofibers were oriented in one direction by replacing an organic solvent in the gel with water.

### <Laser Desorption/Ionization Mass Spectrometry>

### Example 4

First, a substrate (a uniaxially oriented polymeric nanofiber aggregate substrate: a thin film substrate) including an organic silica thin film (thickness: 20 μm) formed of the nanofibers composed of the organic silica (the polymer of NI(amide)-d-Si) obtained in Example 1 was attached to a silicon substrate (support) (a back face of a carbon seal of the thin film substrate was attached to the support) to obtain a silicon substrate including the organic silica thin film (hereinafter sometimes referred to as a “multilayer substrate” for convenience).

Subsequently, the multilayer substrate thus obtained was sealed in a Teflon (registered trademark) container together with a glass bottle in which 25 μL of trimethoxy(1H,1H,2H,2H-nonafluorohexyl)silane was put, followed by heating under a temperature condition of 150° C. for 1 hour under an argon atmosphere to conduct hydrophobization treatment on the multilayer substrate. Note that the proceeding of the hydrophobization treatment was confirmed from the fact that the surface of the multilayer substrate after the treatment exhibited such super water repellency that the contact angle of water droplets was 150 degrees or more.

Next, a plurality of multilayer substrates subjected to such hydrophobization treatment (hydrophobized products of uniaxially oriented polymeric nanofiber aggregate substrates supported on supports) were prepared, and laser desorption/ionization mass spectrometry was conducted by using these as substrates for the laser desorption/ionization mass spectrometry.

In such laser desorption/ionization mass spectrometry, verapamil, angiotensin I, and amyloid β (human, 1-40) were used as molecules to be analyzed, and as sample solutions of these, solutions prepared by dissolving the molecules to be analyzed at predetermined concentrations (verapamil: 1.0 pmol/μL, angiotensin I: 0.5 pmol/μL, and amyloid β: 0.5 pmol/μL) in mixed solvents containing acetonitrile and 0.1% by mass aqueous solution of trifluoroacetic acid such that a volume ratio ([acetonitrile]:[aqueous solution] was 1:4 were used. Then, 1.0 μL of each sample solution was added dropwise onto an organic silica thin film included in the substrate for laser desorption/ionization mass spectrometry and was dried promptly under vacuum to support the molecule to be analyzed on the surface of the substrate, thus forming a measurement sample of each molecule to be analyzed. Subsequently, a portion of each measurement sample which supported the molecule to be analyzed (a portion of the organic silica thin film) was irradiated with laser light (the length of the laser wave: 355 nm) to conduct laser desorption/ionization mass spectrometry. Note that for such laser desorption/ionization mass spectrometry, “autoflex maX” manufactured by Bruker Daltonics was used as a measuring device.

As a result of such measurement, the result (mass spectrum of verapamil) of mass spectrometry conducted on the measurement sample obtained by adding dropwise 1.0 pmol/μL of verapamil (molecular weight: 454.6) is shown in FIG. 21. As is clear from the result shown in FIG. 21 as well, a signal corresponding to a proton adduct of verapamil was clearly observed at a position of mass-to-charge ratio (m/z)=455.1 in the obtained mass spectrum, and it was confirmed that the signal/noise (S/N) ratio was 28.

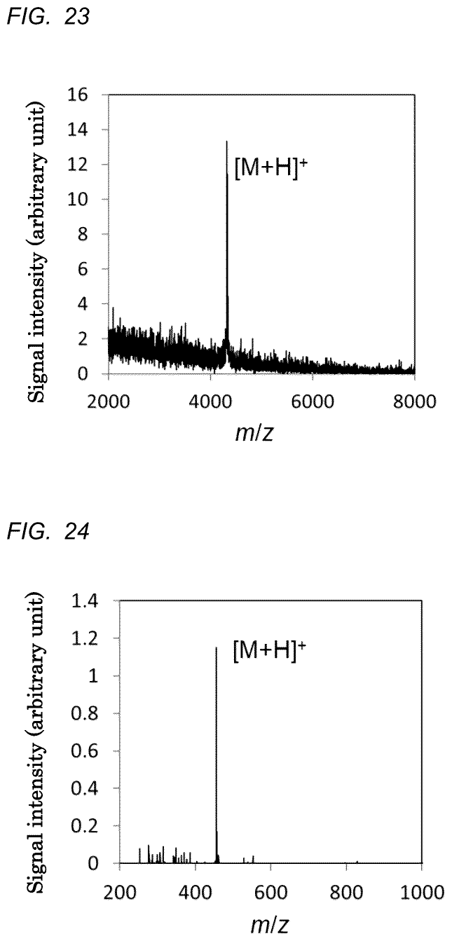

In addition, the result (mass spectrum of angiotensin I) of mass spectrometry conducted on the measurement sample obtained by adding dropwise 0.5 pmol/μL of angiotensin I (molecular weight: 1296.5) is shown in FIG. 22. As is clear from the result shown in FIG. 22 as well, a signal corresponding to a proton adduct of angiotensin I was clearly observed at a position of m/z=1296.6 in the obtained mass spectrum, and it was confirmed that the S/N ratio was 38.

Moreover, the result (mass spectrum of amyloid β) of mass spectrometry conducted on the measurement sample obtained by adding dropwise 0.5 pmol/μL of amyloid β (molecular weight: 4329.8) is shown in FIG. 23. As is clear from the result shown in FIG. 23 as well, a signal corresponding to a proton adduct of amyloid β was clearly observed at a position of m/z=4330, and it was confirmed that the S/N ratio was 24.

### Comparative Example 3

A plurality of substrates subjected to hydrophobization treatment were prepared in the same manner as in Example 4 except that a thin film (substrate) for comparison, which was obtained in Comparative Example 1, was used instead of the uniaxially oriented polymeric nanofiber aggregate substrate obtained in Example 1, and laser desorption/ionization mass spectrometry was conducted by using verapamil, angiotensin I, and amyloid β (human, 1-40) as molecules to be analyzed.

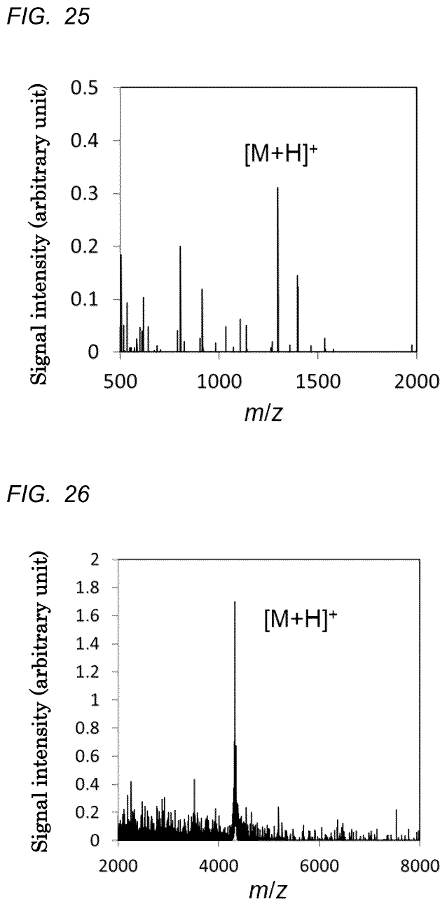

As a result of such measurement, the result (mass spectrum of verapamil) of mass spectrometry conducted on the measurement sample obtained by adding dropwise 1.0 pmol/μL of verapamil (molecular weight: 454.6) is shown in FIG. 24. As is clear from the result shown in FIG. 24 as well, although a signal corresponding to a proton adduct of verapamil was observed at a position of mass-to-charge ratio (m/z)=455.1, the signal intensity was low, and the S/N ratio was 4.

In addition, the result (mass spectrum of angiotensin I) of mass spectrometry conducted on the measurement sample obtained by adding dropwise 0.5 pmol/μL of angiotensin I (molecular weight: 1296.5) is shown in FIG. 25. As is clear from the result shown in FIG. 25 as well, although a signal corresponding to a proton adduct of angiotensin I was observed near a position of m/z=1297, the S/N ratio was below 3 (about 2), so that a sufficient intensity could not be obtained as a signal of mass spectrometry.

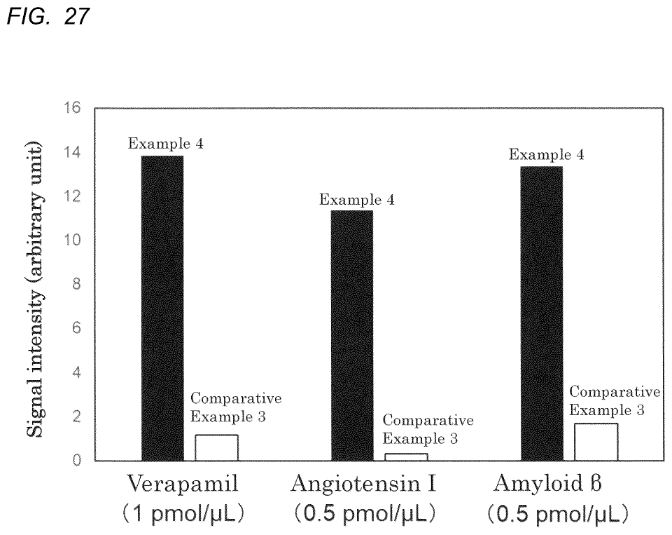

Moreover, the result (mass spectrum of amyloid β) of mass spectrometry conducted on the measurement sample obtained by adding dropwise 0.5 pmol/μL of amyloid β (molecular weight: 4329.8) is shown in FIG. 26. As is clear from the result shown in FIG. 26 as well, although a signal corresponding to a proton adduct of amyloid β was observed at a position of m/z=4330, the signal intensity was low, and the S/N ratio was 6.

Here, a graph in which the signal intensities of the mass spectra of the respective molecules to be analyzed obtained by conducting laser desorption/ionization mass spectrometry in Example 4 and Comparative Example 3 are compared is shown in FIG. 27. As is clear from the result shown in FIG. 27 as well, it was found that in the case where the substrate in which the nanofibers of vertically oriented organic silica were aggregated (Example 4) was used, the performance of mass spectrometry was significantly improved, making it possible to conduct a higher sensitive analysis, as compared with the case where the substrate in which nanofibers of randomly oriented organic silica were aggregated (Comparative Example 3) was used.

As described so far, the present invention makes it possible to provide a method for producing a polymeric nanofiber aggregate capable of efficiently producing a polymeric nanofiber aggregate uniaxially oriented in a longitudinal direction; a polymeric nanofiber aggregate obtained by using the production method; a uniaxially oriented polymeric nanofiber aggregate substrate capable of being efficiently produced as cut products of the polymeric nanofiber aggregate; and a laser desorption/ionization mass spectrometry substrate using the uniaxially oriented polymeric nanofiber aggregate substrate.

Therefore, the method for producing a polymeric nanofiber aggregate of the present invention is useful as a method for efficiently producing a polymeric nanofiber aggregate that can be favorably used as a raw material of a laser desorption/ionization mass spectrometry substrate, and the like.

### REFERENCE SIGNS LIST

10: water-replaced gel-like composition
11: self-assembly fiber bundle
12: polymeric nanofiber aggregate of a form which is fixed (reinforced) with a resin
13: thin film formed of cut products of a polymeric nanofiber aggregate
F: fiber-shaped molecular assembly of a self-assembly compound
Fₚ: nanofiber formed of a polymer
R: resin covering a periphery of a polymeric nanofiber aggregate

What is claimed is:

1. A method for producing a polymeric nanofiber aggregate comprising the steps of:
dispersing a water-insoluble self-assembly compound which has a polymerizable functional group and is capable of forming a fiber-shaped molecular assembly through self-assembly into one solvent of an organic solvent miscible with water and a mixed solvent of the organic solvent and water to obtain a gel-like composition;
replacing the organic solvent in the gel-like composition with water to obtain a water-replaced gel-like composition;
squeezing the water-replaced gel-like composition by compressing the water-replaced gel-like composition in a plurality of directions substantially orthogonal to a longitudinal direction while setting the water-replaced gel-like composition free in the longitudinal direction to obtain a self-assembly fiber bundle; and
polymerizing the self-assembly compound in the self-assembly fiber bundle to obtain an aggregate formed of polymeric nanofibers oriented in the longitudinal direction.

2. The method for producing a polymeric nanofiber aggregate according to claim 1, wherein
the polymerizable functional group is at least one group selected from the group consisting of a trialkoxysilyl group, a vinyl group, an acryloyl group, a methacryloyl group, a dienyl group, and a diacetylene group.

3. The method for producing a polymeric nanofiber aggregate according to claim 1, wherein
the water-insoluble self-assembly compound is an organic silane compound having two or more amide bonds and two or more aromatic groups in a molecular backbone thereof, in which
the two or more aromatic groups are each a group having one aromatic ring selected from the group consisting of a naphthalimide ring, a triphenylamine ring, a pyrene ring, a perylene ring, and an acridone ring, and
two or more trialkoxysilyl groups as the polymerizable functional group bind to the two or more aromatic groups, respectively.

4. A polymeric nanofiber aggregate wherein
nanofibers formed of a polymer of a water-insoluble self-assembly compound which has a polymerizable functional group and is capable of forming a fiber-shaped molecular assembly through self-assembly are oriented and aggregated in a longitudinal direction.

5. A uniaxially oriented polymeric nanofiber aggregate substrate comprising:
a thin film formed of cut products of a polymeric nanofiber aggregate in which nanofibers formed of a polymer of a water-insoluble self-assembly compound which has a polymerizable functional group and is capable of forming a fiber-shaped molecular assembly through self-assembly are oriented and aggregated in a longitudinal direction, wherein
a cutting direction of the cut products is a direction substantially perpendicular to the longitudinal direction of the polymeric nanofiber aggregate.

6. A laser desorption/ionization mass spectrometry substrate comprising:
the uniaxially oriented polymeric nanofiber aggregate substrate according to claim 5 or a hydrophobized product thereof.
